(19) United States
(12) Patent Application Publication
(10) Pub. No.: US 2017/0271640 A1
(43) Pub. Date: Sep. 21, 2017

(54) SEPARATOR ROLL AND METHOD FOR MANUFACTURING SAME

(71) Applicant: Sumitomo Chemical Company, Limited, Tokyo (JP)

(72) Inventor: Akinobu SAKAMOTO, Niihama-shi (JP)

(21) Appl. No.: 15/457,165

(22) Filed: Mar. 13, 2017

(30) Foreign Application Priority Data
Mar. 16, 2016 (JP) 2016-052995

(51) Int. Cl. H01M 2/18; H01M 2/14; H01M 10/04; H01M 10/0525; H01M 10/0587

(52) U.S. Cl. CPC H01M 2/18; H01M 10/0525; H01M 10/0587; H01M 10/0431; H01M 2/145; H01M 2220/20

(57) ABSTRACT

Provided is a separator roll in which deformation is reduced and an external quality is improved. In the separator roll, a separator is wound around a core, and an absolute value of radial stress σᵣ applied to the core is not more than a critical stress σ_{cr}. The critical stress σ_{cr} is a value obtained by multiplying A by B, where: A is an absolute value, of radial stress σᵣ applied to the core, as observed in a case where a maximum value of Von Mises stress σₘ in the core is equal to a yield stress σ_{y} of a material of the core; and B is a safety factor of 0.5.

This Nonprovisional application claims priority under 35 U.S.C. §119 on Patent Application No. 2016-052995 filed in Japan on Mar. 16, 2016, the entire contents of which are hereby incorporated by reference.

### TECHNICAL FIELD

The present invention relates to a separator roll and a method for producing the separator roll.

### BACKGROUND ART

Recently, along with advances in the miniaturization of mobile devices such as notebook-type personal computers, mobile phones, and digital cameras, similar advances are being made in (a) techniques for reducing the size of nonaqueous electrolyte secondary batteries, such as lithium ion secondary batteries, which are used in such devices, and (b) techniques for reducing the thickness of separators used as a member of such batteries (such separators hereinafter also referred to as “nonaqueous electrolyte secondary battery separators”.

A method for producing a nonaqueous electrolyte secondary battery typically involves a plurality of steps, including a step of producing such a nonaqueous electrolyte secondary battery separator having a reduced thickness. As with other types of webbing such as paper, film, and metal film, a nonaqueous electrolyte secondary battery separator that has been produced will often be wound into a roll form in order to facilitate storage and transport to a subsequent step.

With regards to a separator roll produced by winding the nonaqueous electrolyte secondary battery separator into a roll form, it is known that external defects (such as wrinkling and slippage) can occur during winding and during transport, depending on winding conditions and the like.

In particular, in order to improve the efficiency of storage and transference of the separator roll, as well as the efficiency of a battery production step, it is preferable to use a roll whose nonaqueous electrolyte secondary battery separator is long. Furthermore, for a given roll diameter, a thinner nonaqueous electrolyte secondary battery separator corresponds to a greater number of turns. In a roll made by winding a nonaqueous electrolyte secondary battery separator that is long and/or thin, occurrence of the external defects is more marked.

It is known that there is a strong relation between (i) the likelihood with which this problem occurs and (ii) a distribution of internal stress in rolls such as the separator roll.

Theoretical and experimental research has been conducted in order to control the distribution of internal stress in such rolls. Various analytical models for internal stress, and methods for analyzing internal stress distribution in accordance such analytical models, have been provided (see Non-Patent Literature 1 through 6). Furthermore, prior art provides (a) analytical programs for internal stress in a roll (Patent Literature 1, 5, and 6) and (b) winding devices (Patent Literature 2 through 4 and Patent Literature 7). These analytical programs and winding devices are (a) based on the various models and methods for analyzing internal stress distribution (b) used for controlling web winding conditions.

### CITATION LIST

### Patent Literature

### [Patent Literature 1]

Japanese Patent Application Publication, Tokukai, No. 2012-017159 (Publication date: Jan. 26, 2012)

### [Patent Literature 2]

Japanese Patent No. 5606219 (Registered on Sep. 5, 2014)

### [Patent Literature 3]

Japanese Patent No. 5748514 (Registered on May 22, 2015)

### [Patent Literature 4]

Japanese Patent No. 5719689 (Registered on Mar. 27, 2015)

### [Patent Literature 5]

Japanese Patent Application Publication, Tokukai, No. 2013-064650 (Publication date: Apr. 11, 2013)

### [Patent Literature 6]

Japanese Patent No. 5807876 (Registered on Sep. 18, 2015)

### [Patent Literature 7]

Japanese Patent No. 5776077 (Registered on Jul. 17, 2015)

### Non-Patent Literature

### [Non-Patent Literature 1]

“Uebu Handoringu no Kiso Riron to Ouyou” (“Basic Theory and Application of Web Handling”) Hashimoto, Tokai University; Converting Technical Institute, 2008

### [Non-Patent Literature 2]

“Optimum Winding Tension and Nip-Load into Wound Webs for Protecting Wrinkles and Slippage”, Transactions of the Japan Society of Mechanical Engineers (in Japanese) (Part C), vol. 77, no. 774, 2011, 545-555

### [Non-Patent Literature 3]

“A Winding Model for Unsteady Thermal Stress within Wound Roll Considering Entrained Air Effect on Heat Conduction”, Transactions of the Japan Society of Mechanical Engineers (in Japanese) (Part C), vol. 77, no. 780, 2011, 3161-3174

### [Non-Patent Literature 4]

“Research on the Development of Winding Devices High-Performance Plastic Film”, Tokai University Graduate School, doctoral dissertation, academic year of 2013

### [Non-Patent Literature 5]

S. J. Burns, Richard R. Meehan, J. C. Lambropoulos, “Strain-based formulas for stresses in profiled center-wound rolls”, TAPPI Journal, Vol. 82, No. 7, p 159-167 (1999)

### [Non-Patent Literature 6]

J. Paanasalo, “Modelling and control of printing paper surface winding”, [online], date of search: Jan. 12, 2016, URL: http://lib.tkk.fi/Diss/2005/isbn9512277506

### SUMMARY OF INVENTION

### Technical Problem

The methods for analyzing internal stress as provided in the Non-Patent Literature as well as the analytical programs and winding devices provided in the Patent Literature each employ an underlying analytical model in which, regardless of variation in winding tension distribution throughout the winding, as long as tension applied to an outermost layer at the end of winding is the same, stress distribution within the resulting roll will be the same. It is known, however, that in actual production of a roll (separator roll), tension distribution during winding affects internal stress. The above analytical model fails to quantitatively reflect the effects of the tension distribution. As such, with the above conventional analytical model, when producing a roll (separator roll), it is impossible to optimize winding tension distribution so as to inhibit the occurrence of external defects in the resulting roll. The conventional analytical model, therefore, has a problem of failing to enable the production of a roll (separator roll) having an improved external quality.

Note that a reason for which the tension distribution during winding is not quantitatively reflected on internal stress can be described with reference to Non-Patent Literature 1. Page 173 of Non-Patent Literature 1 mentions a numerical solution for a winding equation (described later), and in the right side of Equation (7-39) of Non-Patent Literature 1, only tension applied to the outermost layer is expressed explicitly. As such, tension applied to the outermost layer strongly affects the internal stress of the solution.

The present invention has been made in view of the above problems. An object of the present invention lies in providing a separator roll which allows for (a) a reduction in deformation of a core of the separator roll during production, storage, and transport and (b) an improvement in the external quality of the separator roll.

### Solution to Problem

The inventors of the present invention found that (a) it is possible to optimize the tension distribution in accordance with a model that applies the residual strain model disclosed in Non-Patent Literature 5, and (b) by using an optimized tension distribution, it is possible to produce a separator roll whose external quality is improved. Furthermore, the inventors arrived at the present invention upon finding that, in a separator roll which (a) is produced using the optimized tension distribution and (b) has an improved external quality, an absolute value of radial stress of the separator roll is not more than a certain value. The absolute value of radial stress is a parameter that, conventionally, is not normally subject to measurement in a separator roll.

In other words, a separator roll in accordance with an aspect of the present invention, and a method, for producing the separator roll, in accordance with an aspect of the present invention can be described as follows.

[1] A separator roll including a core and a nonaqueous electrolyte secondary battery separator wound around the core, in which:

the nonaqueous electrolyte secondary battery separator has a wound length of not less than 1,000 m; and

an absolute value of radial stress σᵣ applied to the core is not more than a critical stress σ_{cr},

the critical stress σ_{cr} being a value obtained by multiplying A by B, where: A is an absolute value, of radial stress σᵣ applied to the core, as observed in a case where a maximum value of Von Mises stress σₘ in the core is equal to a yield stress σ_{y} of a material of the core; and B is a safety factor of 0.5.)

[2] The separator roll as described in [1] above, in which the critical stress σ_{cr} is in a range from 0.2 MPa to 2.0 MPa.

[3] The separator roll as described in [1] or [2] above, in which a frictional force between layers of the nonaqueous electrolyte secondary battery separator at a position equivalent to 95% of a maximum winding radius is not less than a value obtained by multiplying (a) a mass of the separator roll by (b) an acceleration equal to 10 times gravity.

[4] The separator roll as described in any one of [1] through [3] above, in which a frictional force between layers of the nonaqueous electrolyte secondary battery separator at a position equivalent to 95% of a maximum winding radius is not less than a value obtained by multiplying (a) a mass of the separator roll by (b) an acceleration equal to 50 times gravity.

[5] The separator roll as described in any one of [1] through [4] above, in which a tangential stress σₜ is a non-negative value.

[6] The separator roll as described in any one of [1] through [5] above, in which a ratio (Eₜ/Eᵣ) is in a range from 5×10³ to 5×10⁵, the ratio (Eₜ/Eᵣ) being a ratio of (a) a tangential Young's modulus Eₜ of the nonaqueous electrolyte secondary battery separator to (b) a radial Young's modulus Eᵣ of the nonaqueous electrolyte secondary battery separator, which radial Young's modulus Eᵣ is observed in a case where an absolute value of radial stress applied to the nonaqueous electrolyte secondary battery separator is 1,000 Pa.

[7] A method for producing the separator roll as described in any one of [1] through [6] above, the method including a winding step of winding the nonaqueous electrolyte secondary battery separator around the core, in which:

out of winding conditions of the winding step, at least a winding tension distribution is optimized in accordance with nonlinear programming.

### Advantageous Effects of Invention

A separator roll in accordance with an aspect of the present invention enables reduced deformation of the core thereof, and therefore brings about an effect of (a) being well-suited for repeated use of the core and (b) having an improved external quality. Furthermore, a method for producing a separator roll in accordance with an aspect of the present invention brings about an effect of enabling production of such a separator roll having an improved external quality.

### BRIEF DESCRIPTION OF DRAWINGS

FIG. 1 is a diagram illustrating a configuration of a separator roll in accordance with an embodiment of the present invention, as well as tangential stress of and radial stress σᵣ of the separator roll.

FIG. 2 is a diagram illustrating a laminated structure of the separator roll in accordance with an embodiment of the present invention, as well as a relation between (a) the laminated structure and (b) radial stress σᵣ and a stress increment δσ.

FIG. 3 is a diagram schematically illustrating a method of measuring a tangential Young's modulus Eₜ of a separator roll. Citation from p. 166 of Non-Patent Literature 1.

FIG. 4 is a diagram schematically illustrating a method of measuring a radial Young's modulus Eᵣ of a separator roll. Citation from p. 166 of Non-Patent Literature 1.

FIG. 5 is a diagram schematically illustrating a configuration of a centrally-driven winding machine including a nip roller, which winding machine is used in the production of a separator roll.

FIG. 6 is a graph showing an example of a winding tension distribution used during winding in production of a separator roll.

FIG. 7 is a graph showing a relation between a radial position R/R_{c} and winding tension, with respect to Examples 1 and 2 and Comparative Example 1.

FIG. 8 is a graph showing a relation between the radial position R/R_{c} and radial stress σᵣ, with respect to Examples 1 and 2 and Comparative Example 1.

FIG. 9 is a graph showing a relation between the radial position R/R_{c} and an absolute value of tangential stress σₜ, with respect to Examples 1 and 2 and Comparative Example 1.

FIG. 10 is a graph showing a relation between the radial position R/R_{c} and a frictional force between separator layers, with respect to Examples 1 and 2 and Comparative Example 1.

FIG. 11 is a graph showing a relation between a radial position R/R_{c} and winding tension, with respect to Example 3 and Comparative Examples 2, 3, and 4.

FIG. 12 is a graph showing a relation between the radial position R/R_{c} and radial stress σᵣ, with respect to Example 3 and Comparative Examples 2, 3, and 4.

FIG. 13 is a graph showing a relation between the radial position R/R_{c} and an absolute value of tangential stress σₜ, with respect to Example 3 and Comparative Examples 2, 3, and 4.

FIG. 14 is a graph showing a relation between the radial position R/R_{c} and a frictional force between separator layers, with respect to Example 3 and Comparative Examples 2, 3, and 4.

### DESCRIPTION OF EMBODIMENTS

The following description will discuss, in detail, an embodiment of the present invention. Note that in the following description, the expression “A˜B” signifies a range between and including A and B.

### Embodiment 1: Separator Roll

A separator roll in accordance with Embodiment 1 of the present invention is a separator roll including a core and a nonaqueous electrolyte secondary battery separator wound around the core, in which separator roll the nonaqueous electrolyte secondary battery separator has a wound length of not less than 1,000 m, and an absolute value of radial stress σᵣ applied to the core is not more than a critical stress σ_{cr}.

[Components of Separator Roll]

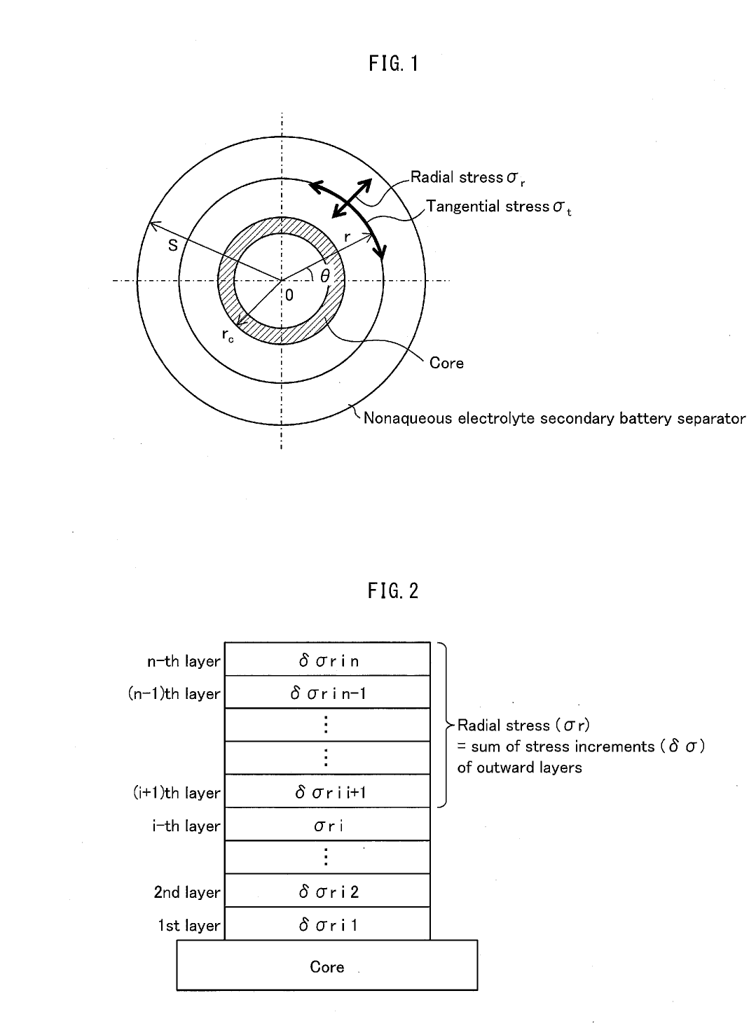

The separator roll in accordance with Embodiment 1 is configured so as to include (a) the core at the center of the separator roll and (b) the nonaqueous electrolyte secondary battery separator wound around the core, as shown in FIG. 1.

[Core]

The separator roll can employ a core typically used as a core of a separator roll. Examples of the material of the core encompass thermoplastic resins such as acrylonitrile-butadiene-styrene copolymer (ABS) resin, polypropylene resin (PP) resin, polyvinyl chloride (PVC) resin, polystyrene (PS) resin, and polycarbonate (PC) resin. These thermoplastic resins can contain an additive such as a filler or antistatic agent to impart functionality such as rigidity or an antistatic property. The ABS resin is generally used as the material of the core. The core can be suitably made from a material having a yield stress σ_{y} in a range from 20 MPa to 80 MPa.

The yield stress σ_{y} of the material of the core is a characteristic value that differs depending on the material constituting the core. Examples of respective yield stresses of various material are shown in Table 1 below (reference: “Journal of the Society of Materials Science, Japan,” 1989, Vol. 35, No. 398, p 1267-1271).

TABLE 1

Yield Stress (Mpa)

| Material | Tensile | Compressive |
|---|---|---|
| Polypropylene resin | 31.5 | 44.2 |
| (PP) resin | | |
| Polyethylene (PE) resin | 19.5 | 22.0 |
| Nylon 6 (PA6) resin | 35.6 | 42.4 |
| Polyvinyl chloride | 52.9 | 64.7 |
| (PVC) resin | | |
| Acrylonitrile- | 34.5 | 49.0 |
| butadiene-styrene | | |
| copolymer (ABS) resin | | |

Note that yield stress is determined by performing a tension test or compression test on a given material. Yield stress is obtained by dividing A by B, where A is external force applied to the material, as observed at a point when yield occurs and elastic deformation of the material changes to plastic deformation (i.e., at point when the deformed material will no longer return to its original form), and B is the cross sectional area of the material. Examples of methods for measuring yield stress include JIS K 7127 (Plastics—Determination of Tensile Properties—Part 3: Test Conditions for Films and Sheets) and 7161 (Plastics—Determination Of Tensile Properties—Part 1: General Principles) for tension tests, and JIS K 7181 (Plastics—Determination of Compressive Properties) for compression tests.

The core of the separator roll has a shape which is not particularly limited. Generally, a cylindrical core can be used. In a case where a cylindrical core is employed, the core preferably has a width (the height of the cylinder) that is either equal to or somewhat wider than a width of the nonaqueous electrolyte secondary battery separator, since such a width facilitates winding of the nonaqueous electrolyte secondary battery separator. Furthermore, the cylindrical core preferably has a radius (the radius of the circular portion of the cylinder) which is in a range from 3 inches to 6 inches (76.2 mm to 152.4 mm). In view of such properties as lightness, storability, transportability, and rigidity of the core, the core is preferably configured to include (a) an outer circumferential part having the above radius, (b) an inner circumferential part whose radius is smaller than the above radius, and (c) a plurality of ribs connecting the outer circumferential part and the inner circumferential part. The radius of the inner circumferential part can be suitably determined in accordance with a radius of a rotational axis of a winding driving device, with one example being a radius in a range from 1 inch to 3 inches. The outer circumferential part having a radius of not less than 3 inches (76.2 mm) is preferable in terms of the rigidity of the core. The outer circumferential part having a radius of not more than 6 inches (152.4 mm) is preferable in terms of the lightness, storability, and transportability of the separator roll.

[Nonaqueous Electrolyte Secondary Battery Separator]

The nonaqueous electrolyte secondary battery separator of the separator roll is not particularly limited, provided that it does not become damaged at the levels of internal stress applied thereto. With regards to radial stress in each part of the separator roll, note that radial stress applied to an i-th layer of the nonaqueous electrolyte secondary battery separator is equal to the sum of stress increments of each layer above the i-th layer, as shown in FIG. 2. As such, the maximum value of radial stress in the separator roll is an absolute value of radial stress σᵣ applied to the core. Note that the “i-th layer” refers to an i-th layer as counted outwardly from the core, where a layer in contact with the core is considered a first layer. As such, the nonaqueous electrolyte secondary battery separator can be a separator which does not become damaged or exhibit significant compressive deformation or the like even if subjected to the radial stress σᵣ applied to the core. Note also that in production of the separator roll, the nonaqueous electrolyte secondary battery separator is generally wound with a certain winding tension applied thereto. As such, the nonaqueous electrolyte secondary battery separator can be a separator which does not become damaged or exhibit significant tensile deformation even if subjected to such a winding tension during winding.

A composition of the nonaqueous electrolyte secondary battery separator is not particularly limited. The nonaqueous electrolyte secondary battery separator can contain, for example, polyolefin as a main component, and need only be a separator which has therein many pores connected to one another, such that a gas or liquid can pass through from one side to another. The nonaqueous electrolyte secondary battery separator can be formed so as to have only a single layer, or, alternatively, so as to have a laminated structure including a plurality of layers, such as a heat-resistant layer and/or a protective layer.

A method of producing the nonaqueous electrolyte secondary battery separator is not particularly limited and can be, for example, a publicly known dry method or wet method. Possible methods include a method in which (a) a pore forming agent is added to a resin such as polyolefin, (b) a film is formed therefrom, and then (c) the pore forming agent is removed by using a suitable solvent.

The nonaqueous electrolyte secondary battery separator preferably has a thickness in a range from 4 μm to 40 μm. The nonaqueous electrolyte secondary battery separator having a thickness of not less than 4 μm is preferable in terms of making it possible to adequately prevent an internal short circuit caused by, for example, damage to a nonaqueous electrolyte secondary battery which contains the nonaqueous electrolyte secondary battery separator. The nonaqueous electrolyte secondary battery separator having a thickness of not more than 40 μm is preferable in terms of preventing an increase in permeation resistance of lithium ions in a nonaqueous electrolyte secondary battery containing the nonaqueous electrolyte secondary battery separator. Preventing such an increase makes it possible to prevent (a) a deterioration of a cathode caused by repeated charge-discharge cycles and (b) a deterioration in the rate and cycle properties of the battery. The thickness being not more than 40 μm is also preferable in terms of preventing an excessive increase in size of the nonaqueous electrolyte secondary battery caused by an increase in the distance between the cathode and an anode thereof.

The nonaqueous electrolyte secondary battery separator has a wound length, i.e., a length parallel to a winding direction, which is not less than 1,000 m, and preferably not less than 1,500 m. The wound length is preferably not greater than 5,000 m. By having a wound length in the above range, the separator roll can contain the nonaqueous electrolyte secondary battery separator in great amounts in a single roll. A conventional separator roll having a nonaqueous electrolyte secondary battery separator whose wound length is 1,000 m or greater tends to experience deterioration in the external quality thereof due to, for example, deformation of the core thereof. The separator roll in accordance with Embodiment 1, however, has internal stress which is suitably controlled. As such, even in a case where the separator roll includes, as a member thereof, a nonaqueous electrolyte secondary battery separator having a wound length of 1,000 m or greater, the separator roll better prevents deformation of the core and has an improved external quality in comparison to a conventional separator roll. Note that with a wound length exceeding 5,000 m, deformation of the core is not adequately prevented, and thus there is a risk of a deterioration in external quality.

The nonaqueous electrolyte secondary battery separator has a width, i.e., a dimension orthogonal to the winding direction, which is preferably in a range from 10 mm to 300 mm, and more preferably in a range from 30 mm to 100 mm.

[Physical Property Values of Separator Roll]

The separator roll in accordance with Embodiment 1 is configured such that an absolute value of radial stress σᵣ applied to the core is not greater than a critical stress σ_{cr}.

[Radial Stress and Tangential Stress]

As shown in FIG. 1, at a position at a given winding radius r in the separator roll, a radial stress σᵣ is applied to the nonaqueous electrolyte secondary battery separator. This radial stress σᵣ compresses each layer of the nonaqueous electrolyte secondary battery separator beneath the position, and simultaneously, the nonaqueous electrolyte secondary battery separator at the position is compressed by layers of the nonaqueous electrolyte secondary battery separator thereabove. The radial stress σᵣ constantly acts in a compression direction, regardless of the radial position. In a case where a radial direction toward the outside of the separator is considered to be positive, the radial stress σᵣ will constantly take on a negative value.

A tangential stress σₜ acts in a tangential direction. Depending on the radial position in the separator roll, this tangential stress σₜ can be either tensile or compressive. The tangential stress σₜ takes on a positive value when tensile, and a negative value when compressive. Since winding tension is applied in a tension direction, generally, the tangential stress σₜ will often be tensile and take on a positive value. Note that in a case where the tangential stress σₜ is a negative value, the nonaqueous electrolyte secondary battery separator is compressed in the winding direction, and thus the external defect known as wrinkling is likely to occur. Wrinkling may also be called a “star defect”. As such, in the separator roll, the tangential stress σₜ preferably has a non-negative value so as to prevent the external defect known as wrinkling.

In a case where the absolute value of the radial stress σᵣ is small, the external defect known as slippage is likely to occur in the vicinity of the outermost layer of a roll, particularly because the absolute value of the radial stress σᵣ at the outermost layer of the roll is 0. Slippage may also be called telescoping. As such, in the separator roll, the absolute value of the radial stress σᵣ is preferably particular value, for example, not less than 0.01 MPa, in order to inhibit the occurrence of the external defect known as slippage.

In a case where the absolute value of the radial stress σᵣ or the absolute value of the tangential stress σₜ is too large, a phenomenon known as creep, where deformation progressively occurs over time, is likely to occur. This causes the nonaqueous electrolyte secondary battery separator to be subject to permanent effects of stretching or compression.

In light of the above, in the separator roll in accordance with Embodiment 1, the absolute value of radial stress σᵣ is preferably in a range from 0.01 MPa to 2.0 MPa, and more preferably in a range from 0.01 MPa to 1.0 MPa. Furthermore, in the separator roll in accordance with Embodiment 1, the tangential stress σₜ is preferably in a range from 0 MPa to 10 MPa, and more preferably in a range from 0 MPa to 8 MPa. The respective absolute values of the radial stress σᵣ and the tangential stress σₜ being in the above respective ranges is preferable in terms of inhibiting the occurrence of external defects in the separator roll.

The radial stress σᵣ applied to the core of the separator roll can be measured by measuring strain of the core.

Specifically, first, the radius of the core is measured prior to winding the separator thereon. Also, the relation between (a) stress applied to the core and (b) strain of the core is measured or calculated in advance (this relation being the radial Young's modulus of the core). The specific method of measuring the radial Young's modulus of the core is not particularly limited, but possible examples include a method where, for example, an external stress is uniformly applied along the circumference of the core, and then the radius of the core is measured. In a range where strain is minute, stress and strain exhibit a linear relation, and the radial Young's modulus of the core can be calculated as the slope of the line of the linear relation. An example of a method for applying stress to the core includes a method where a high-pressure gas or liquid, such as air or water, is caused to contact the outer circumferential part of the core. The radial Young's modulus of the core can be calculated by employing a simulation using elastic theory and finite element analysis which uses (a) a tensile Young's modulus and a Poisson's ratio, which are physical property values of the material of the core and (b) the shape of the core.

Next, once the separator roll is produced, the radius of the core is measured again and compared to the radius measured prior to winding the separator around the core. This makes it possible to measure the amount of strain of the core which is caused by winding the separator therearound. Finally, stress (radial stress σᵣ) applied to the core of the separator roll is calculated from (a) the strain measured as above and (b) the radial Young's modulus of the core calculated as above.

The tangential stress in the separator roll can be measured by measuring stretching of the separator of the separator roll, which stretching occurs in a direction parallel to the winding direction.

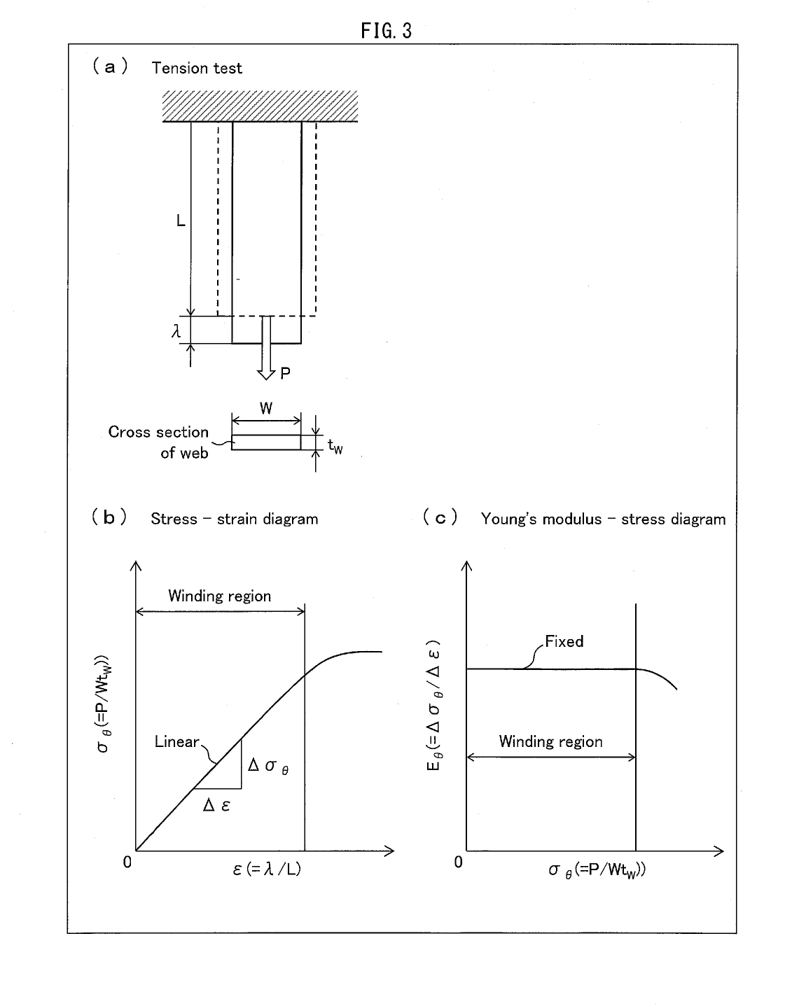

Specifically, first a tangential Young's modulus of the separator is measured. The tangential Young's modulus of the separator can be measured by use of, for example, a tension test as described later (see FIG. 3). Next, two points on the separator roll are marked, the two points being equidistant from the center of the core, and a length of the separator between the two points is measured. Thereafter, the separator is wound off from the core and laid flat, and the distance between the two marked points is measured. By comparing these two measurements, it is possible to measure stretching of the separator which is caused by winding the separator around the core. Finally, tangential stress of the separator roll is calculated from (a) the stretching of the separator and (b) the tangential Young's modulus of the separator.

[Critical Stress]

In the separator roll in accordance with Embodiment 1, the critical stress σ_{cr} is a value obtained by multiplying A by B, where A is the absolute value, of the radial stress σᵣ applied to the core, as observed in a case where a maximum value of Von Mises stress σₘ in the core is equal to a yield stress σ_{y} of the material of the core, and B is a safety factor of 0.5.

The Von Mises stress is an index indicating the internal stress in the core. It is calculated via elastic theory and finite element analysis, where the core is considered an elastic body. Internal stress is, in actuality, constituted by stresses in a plurality of directions, but the Von Mises stress is a value obtained by projecting the internal stress onto tension or compression along a single axis. It is known that when the Von Mises stress reaches a value equal to the yield stress of an object, the object will yield. Thus, “a case where a maximum value of Von Mises stress σₘ in the core is equal to a yield stress σ_{y} of the material of the core” refers to a case where the core yields. As such, in the separator roll in accordance with Embodiment 1, the critical stress σ_{cr} is a value obtained by multiplying (a) an absolute value of the radial stress σᵣ, applied to the core, at which value the core yields, by (b) the safety factor of 0.5.

The critical stress can be determined via a method where, in a simulation using elastic theory and finite element analysis, external stress is applied to the core, and an amount of the external stress at which the core yields is calculated. That is, at a point at which the core yields, the Von Mises stress in the core has a maximum value which is equal to the yield stress of the material of the core. The critical stress σ_{cr} can therefore be calculated as a value obtained by multiplying (a) the amount of the external stress at the point at which the core yields by (b) a safety factor of 0.5.

In the separator roll of Embodiment 1, since the absolute value of the radial stress σᵣ, applied to the core is not greater than the critical stress σ_{cr}, the core is reliably prevented from yielding. As such, the core is prevented from deforming irreversibly, or the amount of deformation is kept to a minimum, and thus the external quality of the separator roll is further improved. This also facilitates repeated reuse of the core.

Normally, since a core made from resin is costly, it is intended to be used repeatedly. With repeated use, however, the core is likely to become permanently deformed, partially cracked, and/or partially chipped. There is therefore a limit to the number of times a core can be used. With the separator roll in accordance with Embodiment 1, however, the absolute value of the radial stress σᵣ applied to the core is not greater than the critical stress σ_{cr}. As such, even when compared to a publicly known separator roll which may have an exterior of similar quality, the separator roll in accordance with Embodiment 1 is advantageous with regards to the number of times the core can be reused.

The critical stress σ_{cr} can differ depending on the material and/or shape of the core, but in a case where the core employs a typical material and shape, the critical stress σ_{cr} is preferably in a range from 0.2 MPa to 2.0 MPa, and more preferably in a range from 0.2 MPa to 1.0 MPa. The critical stress σ_{cr} of the core being not less than 0.2 MPa is preferable because in such a case, the core has a sufficient strength and thus deformation of the core can be adequately inhibited. In a case where the critical stress σ_{cr} of the core exceeds 2.0 MPa, although the core will have a sufficient strength, the core will be thick and have an increased weight. Such a critical stress σ_{cr} is therefore not preferable in terms of, for example, transportability.

[Frictional Force Between Separator Layers]

In the separator roll in accordance with Embodiment 1, at a position equivalent to 95% of a maximum winding radius, frictional force between separator layers is preferably not less than a critical frictional force F_{cr} (described later).

In considering a separator roll, including a core, as an object to be transported, it is known that the external defect known as slippage is likely to occur in a case where the separator roll is subjected to high levels of force and acceleration during transport. This is presumably due to the fact that, during transport, external force caused by acceleration is applied to an outer surface of the roll, resulting in shifting between separator layers and slippage.

Note here that critical frictional force refers to a minimum frictional force at which slippage occurs. The critical frictional force is dependent on the level of acceleration undergone by the roll during transport. Specifically, from the equation force=mass×acceleration, the critical frictional force is obtained as the product of (a) the entire mass of the roll (unit: kg) and (b) acceleration undergone by the roll during transport (unit: m/s²).

Acceleration is affected by, for example, the means of transport and packing. Generally, however, in a case where the separator roll is packed into cardboard and transport by truck, the acceleration will be approximately 50 G (=50×gravitational acceleration 9.8 m/s²=490 m/s²), and in a case where the separator roll is packed in a shipping container and transported by ship, the acceleration will be approximately 10 G (=10×gravitational acceleration 9.8 m/s²=98 m/s²). For example, in a case where a separator roll to be shipped, including the core thereof, has a total mass of 1.4 kg, if it is assumed that the separator roll is to be packed into a shipping container and transported by ship, the acceleration will generally be 10 G. In such a case, the critical frictional force F_{cr} is therefore calculated as 1.4 kg×98 m/s²=approximately 140 N. Alternatively, assuming a case where a separator roll of the same mass is to be packed in cardboard and transported by truck, the acceleration will generally be 50 G, and as such the critical frictional force F_{cr} is calculated as 1.4 kg×490 m/s²=approximately 700N. Setting the frictional force Fᵢ, between layers of the nonaqueous electrolyte secondary battery separator, so as to be equal to or greater than F_{cr} makes it possible to prevent the external defect known as slippage.

Note however, that in a later-described equation for calculating the frictional force between layers of the nonaqueous electrolyte secondary battery separator, the frictional force is constantly zero at the outermost layer of the roll. As such, in the present disclosure, it is presumed that, in a case where the frictional force between layers of the nonaqueous electrolyte secondary battery separator is equal to or greater than the critical frictional force at a position equivalent to 95% of the maximum winding radius of the roll, the external defect known as slippage will be prevented at least in an area from (a) the innermost layer to (b) the position equivalent to 95% of the maximum winding radius. Such a configuration is therefore presumed to be preferable in terms of preventing the external defect known as slippage throughout the entirety of the separator roll. Note that, hereinafter, the frictional force between layers of the nonaqueous electrolyte secondary battery separator at a position equivalent to 95% of the maximum winding radius is also referred to as F95.

More specifically, in the separator roll in accordance with Embodiment 1, the frictional force between separator layers at a position equivalent to 95% of the maximum winding radius is preferably not less than a value obtained by multiplying (a) the mass of the separator roll by (b) an acceleration equal to ten times gravity, and more preferably not less than a value obtained by multiplying (c) the mass of the separator roll by (b) an acceleration equal to twelve times gravity.

As a more specific example of the above, the frictional force F95 is preferably not less than, for example, 0.14 kN. The frictional force F95 being within the above range is preferable in that it prevents the external defect known as slippage in a case where the separator roll is to be packed in a shipping container and transported by ship.

Alternatively, in the separator roll in accordance with Embodiment 1, the frictional force between separator layers at a position equivalent to 95% of the maximum winding radius is preferably not less than a value obtained by multiplying (a) the mass of the separator roll by (b) an acceleration equal to 50 times gravity, and more preferably not less than a value obtained by multiplying (c) the mass of the separator roll by (b) an acceleration equal to 60 times gravity.

As a more specific example of the above, the frictional force F95 is preferably not less than, for example, 0.70 kN. The frictional force F95 being within the above range is preferable in that it prevents the external defect known as slippage in a case where the separator roll is to be packed in cardboard and transported by truck.

The frictional force between separator layers can be calculated with reference to Equations (33) and (34) (described later), and is defined as the product of (a) a coefficient of friction μ_{eff} between separator layers and (b) a normal force.

The coefficient of friction μ_{eff} between separator layers of a separator roll can be calculated by referring to Equation (34) and utilizing (a) a thickness of an air layer (h) between separator layers which air layer is compressed due to winding, (b) a coefficient of static friction (μ_{ff}) between separator layers, and (c) a composite root square roughness (σ_{ff}) between separator layers. The thickness of the air layer (h) between separator layers can be calculated by using Equation (22) (described later). The coefficient of static friction (μ_{ff}) can be measured by a method such as that of JIS K 7125 (Plastics—Film and sheeting—Determination of the coefficients of friction). The composite root square roughness (σ_{ff}) is calculated with reference to Equation (11). Equation (11) utilizes the respective root mean square roughnesses of an inward-facing separator surface and an outward-facing separator surface, and these values can be measured via a method with reference to JIS B 0601 (Geometrical Product Specifications (GPS)—Surface texture: Profile method—Terms, definitions and surface texture parameters).

Note that the normal force differs depending on a distance r from the center of the core. The normal force is obtained as the product of (a) the absolute value of radial stress σᵣ at the distance r and (b) an area S upon which frictional force acts (this area being equivalent to a circumferential surface area of a column whose radius is the distance r and whose height is the width of the separator). As such, the frictional force between separator layers is calculated as μ_{eff}×|σᵣ|×S.

Note that this method can be used to calculate the frictional force F95, by using the value of the position equivalent to 95% of the maximum winding radius as the value for the distance r.

[Young's Modulus]

In the separator roll in accordance with Embodiment 1, a ratio (Eₜ/Eᵣ) is preferably in a range from 5×10³ to 5×10⁵, and more preferably in a range from 10⁴ to 5×10⁵, the ratio (Eₜ/Eᵣ) being a ratio of (a) a tangential Young's modulus Eₜ of the nonaqueous electrolyte secondary battery separator to (b) a radial Young's modulus Eᵣ of the nonaqueous electrolyte secondary battery separator, which radial Young's modulus Eᵣ is observed in a case where an absolute value of radial stress applied to the nonaqueous electrolyte secondary battery separator is 1,000 Pa. The ratio (Eₜ/Eᵣ) of the Young's moduli being within the above ranges is preferable in that it facilitates a reduction in the respective absolute values of radial stress and tangential stress in the separator roll, thereby preventing deformation of the core and improving the external quality of the separator roll.

The reason for this can be explained with reference to Equations (2), (3), and (8) (described later), which are winding equations which determine radial stress in the separator roll. The respective left sides of these winding equations includes a term of (E_{teq}/E_{req}), which is strongly related to the above (Eₜ/Eᵣ). E_{teq} and E_{req}, which can be determined by using Equations (18) and (19) (described later), are obtained by correcting Eₜ and Eᵣ, respectively, by considering the separator and an air layer to be a single equivalent layer. As such, it can be considered that (E_{teq}/E_{req}) is approximately equal to (Eₜ/Eᵣ) and is, in the winding equations, an important property value regarding the separator.

Note that the radial Young's modulus Eᵣ is a function of applied radial stress and is defined in Equation (23) (described later). As such, the ratio (Eₜ/Eᵣ) of the Young's moduli is also a function of radial stress, and, here, 1,000 Pa is used as an absolute value of radial stress of to define the range thereof.

Table 2 indicates various ratios (Eₜ/Eᵣ) of the Young's moduli, as calculated from Patent Literature 1 through 3, and Patent Literature 5 and 6. Though Table 2 does not include ratios for separators in particular, the indicated values are for publicly known PP films and PET films.

TABLE 2

| | | Eᵣ | Eₜ/Eᵣ |
|---|---|---|---|
| Patent Literature | Eₜ | (\|σᵣ\| = 1,000 Pa) | (\|σᵣ\| = 1,000 Pa) |
| Patent Literature 1 | 5.18 × 10⁹ | 5.66 × 10⁶ | 9.2 × 10² |
| Patent Literature 2 | 4.80 × 10⁹ | 3.61 × 10⁶ | 1.3 × 10³ |
| Patent Literature 3 | 5.18 × 10⁹ | 1.85 × 10⁶ | 2.8 × 10³ |
| Patent Literature 5 | 2.33 × 10⁹ | 1.68 × 10⁶ | 1.4 × 10³ |
| Patent Literature 6 | 5.18 × 10⁹ | 1.85 × 10⁶ | 2.8 × 10³ |

As shown above, the ratio (Eₜ/Eᵣ) of the Young's moduli as observed in publicly known films has a value lower than the range of that of Embodiment 1 of the present invention. As such, with publicly known films, the respective absolute values of radial and tangential stress in a film roll are likely to be high.

The tangential Young's modulus of the separator of Embodiment 1 can be measured by using a tension test in the same manner as with a normal film, as shown in FIG. 3. The tangential Young's modulus of the separator of Embodiment 1 has a fixed value which is not dependent on the amount of tensile stress, as with a normal film. That is, the tangential Young's modulus is dependent on, for example, the structure and material of the nonaqueous electrolyte secondary battery separator constituting the separator roll.

The separator roll in accordance with Embodiment 1 has a tangential Young's modulus Eₜ which is preferably in a range from 2 GPa to 20 GPa, and more preferably in a range from 5 GPa to 20 GPa. That is, a nonaqueous electrolyte secondary battery separator which, when tested as in the tension test of FIG. 3, is found to have a tangential Young's modulus in the above range can be suitably used in the separator roll in accordance with Embodiment 1.

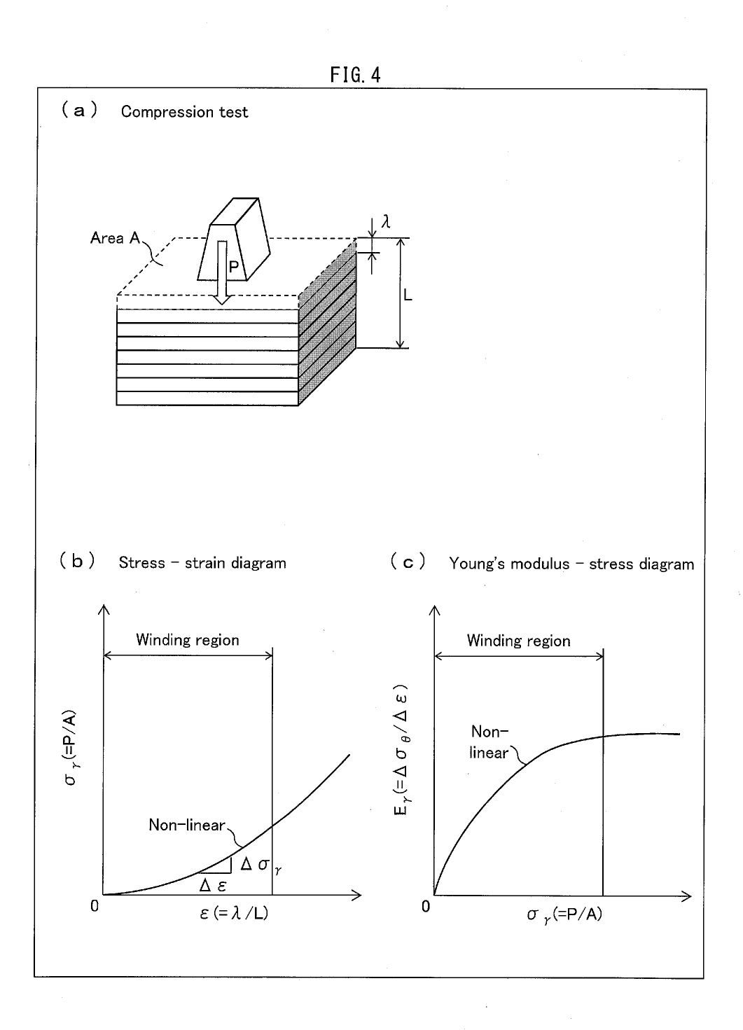

The radial Young's modulus, on the other hand, can be measured by using a compression test as shown in FIG. 4. Since a stress-strain diagram obtained by such a measurement is nonlinear, the radial Young's modulus is dependent on the amount of compressive stress (radial stress) applied to the nonaqueous electrolyte secondary battery separator.

In Embodiment 1 of the present invention, the radial Young's modulus Eᵣ, as observed in a case where a compressive stress (radial stress) of 1,000 Pa is applied to the nonaqueous electrolyte secondary battery separator, is preferably in a range from 10⁵ to 10⁶, and more preferably in a range from 10⁵ to 6×10⁵. That is, a nonaqueous electrolyte secondary battery separator which, upon being tested as in the compression test of FIG. 4, is found to have a radial Young's modulus in the above range in a case where a stress P of 1,000 Pa is applied, can be suitably used in the separator roll in accordance with Embodiment 1 of the present invention.

[Method for Production]

A separator roll in accordance with an embodiment of the present invention can be produced by a method in which a nonaqueous electrolyte secondary battery separator is wound around a core by using a winding tension chosen suitably in accordance with (a) the ratio Eₜ/Eᵣ of the Young's moduli of the nonaqueous electrolyte secondary battery separator (the ratio Eₜ/Eᵣ as observed in a case where an absolute value of radial stress is 1,000 Pa) and (b) the critical stress of the core.

Note that, in general, a lower winding tension corresponds to a lower radial stress in a separator roll. As such, the winding tension need only be adjusted such that radial stress in the separator roll will be not greater than the critical stress of the core. Note also that, in particular, using a method for production (optimization of winding tension) as described with regards to Embodiment 2 of the present invention described below makes it possible to produce a separator roll in which deformation of the core is prevented and/or external quality is improved.

### Embodiment 2: Method for Producing Separator Roll

A method in accordance with Embodiment 2 of the present invention is a method for producing the separator roll in accordance with Embodiment 1 of the present invention, the method including a winding step of winding the nonaqueous electrolyte secondary battery separator around the core, in which out of winding conditions of the winding step, at least a winding tension distribution is optimized in accordance with nonlinear programming. Using the method in accordance with Embodiment 2 of the present invention makes it possible to produce the separator roll in accordance with Embodiment 1 of the present invention, which separator roll has a favorable external quality.

The following description will discuss the method for producing the separator roll in accordance with Embodiment 2. Note that a core and a nonaqueous electrolyte secondary battery separator as described in Embodiment 1 can be suitably utilized in the method for producing the separator roll in accordance with Embodiment 2.

[Winding Step]

The winding step of the method of Embodiment 2 is a step of winding the nonaqueous electrolyte secondary battery separator around the core. A winding method and a winding device used in the winding step are not particularly limited. A winding method and a winding device typically used in producing a separator roll can be employed.

A winding device used in the method of Embodiment 2 can be, for example, a centrally-driven winding device. Generally, a winding device which includes a nip roller in order to reduce an amount of entrained air incorporated into the separator roll during winding can be used as the winding device in the method of Embodiment 2.

In order to facilitate optimization of the winding tension distribution (described later), the various rollers included in the winding device are more preferably not free rollers, but rather speed-adjustable driven rollers. This is because free rollers have bearings whose frictional drag is likely to cause difficulty in conveyance during winding at low winding tensions. Furthermore, with regards to a nip roller, in a case where the load placed on the separator is to be altered during winding and thus the nip load distribution is to be optimized, it is preferable to use a variable-load device. For example, it is preferable to use a device, including a pneumatic compression cylinder, for which pneumatic pressure can be controlled during winding.

[Optimization of Winding Conditions (Tension Distribution)]

In the winding step, out of the winding conditions, at least the winding tension distribution is optimized in accordance with nonlinear programming. First, the model described below is used to analyze a relation between (a) the distribution of winding tension applied to the nonaqueous electrolyte secondary battery separator in the winding step and (b) radial stress, tangential stress, and frictional force between layers of the nonaqueous electrolyte secondary battery separator in the separator roll. Thereafter, optimization is performed in accordance with nonlinear programming based on the results of the analysis. The following description will discuss a method of the analysis and a method of the optimization.

[Analysis Method]

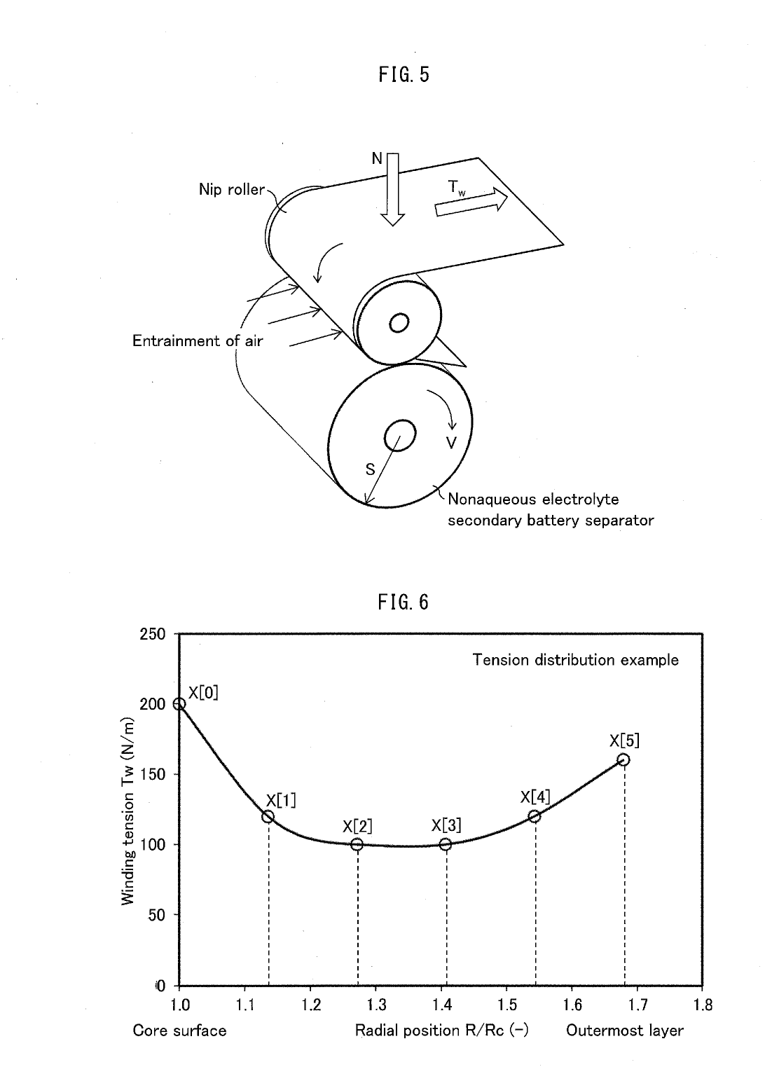

In the separator roll in accordance with an embodiment of the present invention, a relation between (a) various physical property values of the separator, the core and the nip roller, as well as the winding tension used during winding and (b) stress distribution and the like in a roll produced by winding can be analyzed by the method below. Note that the following description assumes the use of a centrally-driven winding system winding machine (as illustrated in FIG. 5) in a winding step.

In the separator roll in accordance with an aspect of the present invention, radial stress σᵣᵢ at an i-th layer is obtained by taking the summation of stress increments δσᵣᵢⱼ as observed at each of an (i+1)th layer through an n-th layer (outermost layer). This is expressed by Equation 1 below (see FIG. 2).

$$\begin{matrix}[ Math . 1 ] & \\ {σ}_{ri} = {\sum }_{j = i + 1}^{n} {δσ}_{rij} & ( 1 )\end{matrix}$$

Provided that δσᵣᵢⱼ expresses a stress increment at a j-th layer in a case where the film is wound to an i-th layer.

An equation which determines δσᵣᵢⱼ of Equation (1) is generally expressed by Equation (2) (note that the indices “i” and “j” are omitted). Equation (2), which can be used in the field to which the present invention belongs, is called a winding equation.

$$\begin{matrix}[ Math . 2 ] & \\ {r}^{2} \frac{{d}^{ 2} {δσ}_{r}}{{dr}^{ 2}} + ( 3 - {v}_{rt} ) r \frac{d {δσ}_{r}}{dr} + ( 1 + {v}_{rt} - \frac{{E}_{teq}}{{E}_{req}} ) {δσ}_{r} = 0 & ( 2 )\end{matrix}$$

(In the above equation, E_{teq} and E_{req} represent property values in the tangential direction and the radial direction, respectively, which property values are obtained when considering the nonaqueous electrolyte secondary battery separator and an air layer together as a single equivalent layer. E_{teq} and E_{req} are obtained using Equations (18) and (19), respectively. Note also that νᵣₜ is the Poisson's ratio of the nonaqueous electrolyte secondary battery separator.)

Note, however, that with Equation (2), it is impossible to reflect how a winding tension distribution during winding affects internal stress in the roll. In order to address this issue, an aspect of the present invention utilizes a winding equation represented by Equation (3). Equation (3) is obtained by applying the residual strain model disclosed in Non-Patent Literature 5 to Equation (2). This makes it possible to reflect the effect of winding tension distribution.

$$\begin{matrix}[ Math . 3 ] & \\ {r}^{2} \frac{{d}^{ 2} {δσ}_{r}}{{dr}^{ 2}} + ( 3 - {v}_{rt} ) r \frac{d {δσ}_{r}}{dr} + ( 1 + {v}_{rt} - \frac{{E}_{teq}}{{E}_{req}} ) {δσ}_{r} = {δσ}^{*} ( r ) & ( 3 )\end{matrix}$$

In Equation (3), the left side is identical to that of Equation (2), while δσ*(r) on the right side takes into consideration residual strain. Note that, as with Equation (1), σ represents stress, while δσ represents a stress increment. Note also that stress σ* caused by residual strain is expressed by Equation (4), which is also disclosed in Non-Patent Literature 5.

$$\begin{matrix}[ Math . 4 ] & \\ {σ}^{*} ( r ) = \frac{{s}_{33} \{ \frac{1}{{E}_{22}} \frac{d}{dr} [ r {σ}_{w} ( r ) ] + \frac{v}{{E}_{22}} {σ}_{w} ( r ) \}}{{s}_{22} {s}_{33} - {s}_{23}^{2}} & ( 4 )\end{matrix}$$

σ_{w} represents force per unit area and is obtained by dividing (a) winding force per unit width, i.e., winding tension (unit: N/m) by (b) thickness. In other words, σ_{w} represents winding stress. Equation (5) is obtained by arranging Equation 4 so as to (a) express Poisson's ratio (ν) by using of the notation of the present invention and (b) express winding stress as a stress increment.

$$\begin{matrix}[ Math . 5 ] & \\ {δσ}^{*} ( r ) = \frac{{s}_{33} \{ \frac{1}{{E}_{22}} \frac{d}{dr} ( r δ {σ}_{w} ( r ) ) + \frac{{v}_{rt}}{{E}_{22}} {δσ}_{w} ( r ) \}}{{s}_{22} {s}_{33} - {s}_{23}^{2}} & ( 5 )\end{matrix}$$

Here, the relational expression of Equation (6) holds true (see Non-Patent Literature 5).

[Math.6]

s₂₃=0, s₂₂E₂₂=1 (6)

Applying Equation (6) to Equation (5) and subsequently arranging the result thereof provides Equation (7).

$$\begin{matrix}[ Math . 7 ] & \\ {δσ}^{*} ( r ) = ( 1 + {v}_{rt} ) δ {σ}_{w} ( r ) + r \frac{d {δσ}_{w} ( r )}{dr} & ( 7 )\end{matrix}$$

Substituting Equation (7) into Equation (3) finally provides Equation (8), which is a winding equation with a residual strain model applied thereto.

$$\begin{matrix} [ Math . 8 ] & \\ {r}^{2} \frac{{d }^{2} {δσ}_{r}}{{dr}^{ 2}} + ( 3 - {v}_{rt} ) r \frac{d {δσ}_{r}}{dr} + ( 1 + {v}_{rt} - \frac{{E}_{teq}}{{E}_{req}} ) {δσ}_{r} = ( 1 + {v}_{rt} ) δ {σ}_{w} ( r ) + r \frac{d {δσ}_{w} ( r )}{dr} & ( 8 )\end{matrix}$$

The winding stress σ_{w}, the winding stress increment δσ_{w}, and the winding tension T_{w} are related as expressed by Equation (9), and δσ_{w} can be expressed by use of T_{w}. As such, it is possible to quantitatively express the right side of Winding Equation (8) by use of winding tension distribution function T_{w}(r).

$$\begin{matrix}[ Math . 9 ] & \\ {σ}_{w} ( r ) = {σ}_{w} ( r + dr ) + {δσ}_{w} ( r + dr ) = \frac{{T}_{w} ( r ) + {µ}_{eff 0} ( r ) \times ( N / W )}{{t}_{f 0}} & ( 9 )\end{matrix}$$

Note that the denominator on the right side of Equation (9) is an initial thickness t_{f0} of the nonaqueous electrolyte secondary battery separator prior to winding, and the numerator is the sum of (a) the winding tension distribution function T_{w}(r) and (b) an induced component due to a nip load N.

Here, W represents the width of the nonaqueous electrolyte secondary battery separator, and, similarly to the unit of winding tension, the induced component is obtained by multiplying (a) the nip load per unit width (N/W) by (b) an initial effective coefficient of static friction (μ_{eff0}) at a nipped portion. Note that an effective coefficient of static friction is a value at the nipped portion, i.e. at the position of nipping by the nip roller, which value signifies a coefficient of friction between (a) the nonaqueous electrolyte secondary battery separator in contact with the nip roller and (b) the nonaqueous electrolyte secondary battery separator therebeneath. Note also that the “initial effective coefficient of static friction” refers to a coefficient of friction, at the position of nipping by the nip roller, between (a) the nonaqueous electrolyte secondary battery separator in contact with the nip roller and (b) the nonaqueous electrolyte secondary battery separator therebeneath, when the nonaqueous electrolyte secondary battery separator is first being wound around the core.

The effective coefficient of static friction (μ_{eff0}) has a value which is dependent on the radial position r and can be obtained by use of Equation (10) below. The effective coefficient of static friction (μ_{eff0}) is classified into three divisions in accordance with the initial value of an air layer thickness (h₀). Note that a method for determining the air layer thickness is later discussed. In a case where the air layer thickness is less than a composite root square roughness (σ_{ff}), the effective coefficient of static friction (μ_{eff0}) becomes the coefficient of static friction (μ_{ff}) between the layers of nonaqueous electrolyte secondary battery separator in contact with each other. In a case where the thickness of the air layer is greater than three times the composite root square roughness (σ_{ff}), frictional force is considered not to have an effect, and the effective coefficient of static friction (μ_{eff0}) becomes 0. In an intermediate case where the thickness of the air layer is (a) not less than the composite root square roughness (σ_{ff}) and (b) not greater than three times the composite root square roughness (σ_{ff}), the effective coefficient of static friction (μ_{eff0}) is expressed by a linear function relating to the thickness of the air layer.

$$\begin{matrix}[ Math . 10 ] & \\ {μ}_{eff 0} = \{ \begin{matrix}{μ}_{ff} & ( {h}_{0} < {σ}_{ff} ) \\ \frac{{μ}_{ff}}{2} ( 3 - \frac{{h}_{0}}{{σ}_{ff}} ) & ( {σ}_{ff} ≦ {h}_{0} ≦ 3 {σ}_{ff} ) \\ 0 & ( {h}_{0} > 3 {σ}_{ff} )\end{matrix} & ( 10 )\end{matrix}$$

The composite root square roughness (σ_{ff}) is defined in Equation (11). Here, σ_{f1} and σ_{f2} are the root mean square roughnesses of an outward-facing surface of the nonaqueous electrolyte secondary battery separator and an inward-facing surface of the nonaqueous electrolyte secondary battery separator, respectively.

[Math.11]

σ_{ff}=\sqrt{σ_{f1}²+σ_{f2}²} (11)

The following description discusses a method for obtaining the initial value of the air layer thickness (h₀) at the nipped portion. Equation (13) is used to obtain an equivalent radius (R_{eq}) from (a) a radius (Rₙᵢₚ) of the nip roller and (b) an outermost layer position (r=s) of the separator roll. Equation (14) is used to obtain an equivalent Young's modulus (E_{eq}) from (a) a radial Young's modulus (Eᵣ) of the separator roll, defined later in Equation (23) and (b) a Young's modulus (Eₙᵢₚ) of the nip roller. In Equation (14), νₙᵢₚ represents a Poisson's ratio of the nip roller, and “|ᵣ₌ₛ” indicates that the radial Young's modulus (Eᵣ) is a value at the outermost layer position (r=s) of the separator roll.

By substituting the equivalent radius (R_{eq}) and the equivalent Young's modulus (E_{eq}) into Equation (12), it becomes possible to obtain the air layer thickness (h₀). Note that ηₐᵢᵣ represents the viscosity of air, and V represents winding speed.

In Equation (14), since the radial Young's modulus (Eᵣ) of the separator roll is a value at the outermost layer position (r=s) of the separator roll, a loop calculation is necessary. First, an arbitrarily chosen air layer thickness (h₀₁) is assumed, and the effective coefficient of static friction (μ_{eff0}) is obtained by use of Equation (10). Next, a boundary condition (15) (described later) can be used to obtain a stress increment (δσ_{r|r=s}) at the outermost layer. The air layer thickness (h₀) is an air layer formed between (a) the n-th layer, which is the outermost layer, and (b) an (n−1)th layer. Radial stress σᵣ at the (n−1)th layer acts on this air layer. Note that radial stress σᵣ at the n-th layer is 0.

Radial stress σᵣ at the (n−1)th layer is δσ_{r|r=s} from Equation (1). By substituting this into Equation (23), it is possible to obtain E_{r|r=s}. By obtaining the equivalent Young's modulus (E_{eq}) from Equation (14) and the equivalent radius (R_{eq}) from Equation (13), it becomes possible to obtain an air layer thickness (h₀₂) from Equation (12).

If there is a significant difference between (a) the air layer thickness (h₀₁) that has been assumed and (b) the air layer thickness (h₀₂), the former is replaced by the latter in Equation (10), and loop calculations are repeated until a significant difference no longer appears, so as to determine the air layer thickness (h₀).

$$\begin{matrix}[ Math . 12 ] & \\ {h}_{0} = 7.43 {{R}_{eq} ( \frac{{η}_{air} V}{{E}_{eq} {R}_{eq}} )}^{0.65} {( \frac{N}{{R}_{eq} {R}_{eq}^{2}} )}^{- 0.23} & ( 12 ) \\ {R}_{eq} = \frac{1}{\frac{1}{s} + \frac{1}{{R}_{nip}}} & ( 13 ) \\ {E}_{eq} = \frac{1}{\frac{1 - {v}_{rt}^{2}}{{E}_{r} {\vert}_{r = s}} + \frac{1 - {v}_{nip}^{2}}{{E}_{nip}}} & ( 14 )\end{matrix}$$

Winding Equation (8) is a non-linear second order ordinary differential equation, and two boundary conditions are required, at the outermost layer (r=s) and an innermost layer (r=r_{c}: core radius) of the separator roll.

Equation (15) expresses the boundary condition at the outermost layer (r=s), whereas Equation (16) expresses the boundary condition at the innermost layer (r=r_{c}). In Equation (16), E_{c} represents a radial Young's modulus of the core. These boundary conditions are not particularly limited, but the examples given here are widely used in the literature of the art.

In view of maintaining consistency with results of calculations from the various literatures, in the present invention, Equation (17) is applied in place of Equation (16), with reference to Non-Patent Literature 6. Here, Eᵣ(i) and δσᵣ(i) signify values at an i-th layer.

$$\begin{matrix}[ Math . 13 ] & \\ δ {σ}_{r} {\vert}_{r = s} = - \frac{{T}_{w} {\vert}_{r = s} + {μ}_{eff 0} ( N / W )}{s} & ( 15 ) \\ {{\frac{d {δσ}_{r}}{dr} \vert}_{r = {r}_{c}} = ( \frac{{E}_{teq}}{{E}_{c}} - 1 + {v}_{rt} ) \frac{{δσ}_{r}}{r} \vert}_{r = {r}_{c}} & ( 16 ) \\ \frac{δ {σ}_{r} {\vert}_{r = {r}_{c}}}{{E}_{c}} {r}_{c} + {\sum }_{i = 1}^{n} \frac{δ {σ}_{r} ( i )}{{E}_{r} ( i )} {t}_{f 0} = 0 & ( 17 )\end{matrix}$$

The following description will discuss E_{req} and E_{teq} of Winding Equation (8). A thickness (t_{f}) of the nonaqueous electrolyte secondary battery separator being compressed by winding can be obtained by use of Equation (21) (described later). An air layer thickness (h) of an air layer being compressed by winding can be obtained by use of Equation (22) (described later). The thickness (t_{f}) of the compressed nonaqueous electrolyte secondary battery separator and the air layer thickness (h) of the compressed air layer are considered together as a single equivalent layer in (a) Equation (18), which provides the radial Young's modulus (E_{req}) of the equivalent layer, and (b) Equation (19), which provides the tangential Young's modulus (E_{teq}) of the equivalent layer. Note that Eᵣₐ, provided by Equation (20), represents the radial Young's modulus of the air layer. See Non-Patent Literature 3 with regards to Equations (18) and (19).

$$\begin{matrix}[ Math . 14 ] & \\ {E}_{req} = \{ \begin{matrix}{E}_{r} & ( h ≦ {σ}_{ff} ) \\ \frac{{t}_{f} + h}{\frac{{t}_{f}}{{E}_{r}} + \frac{h}{{E}_{ra}}} & ( h > {σ}_{ff} )\end{matrix} & ( 18 ) \\ {E}_{teq} = \frac{{t}_{f}}{{t}_{f} + h} {E}_{t} & ( 19 ) \\ {E}_{ra} = \frac{{( \vert {σ}_{r} \vert + {P}_{a} )}^{2}}{{( {T}_{w} \vert}_{r = s} + {μ}_{eff 0} ( N / W ) ) / s + {P}_{a} } & ( 20 )\end{matrix}$$

Here, |X| represents the absolute value of X. Radial stress σᵣ is stress in a direction of compression and is a negative value. As such, the absolute value thereof is used in Equation (20). Pₐ represents atmospheric pressure.

The thickness t_{f} of the compressed nonaqueous electrolyte secondary battery separator and the air layer thickness h of the compressed air layer are provided by Equations (21) and (22), respectively.

$$\begin{matrix}[ Math . 15 ] & \\ {t}_{f} = ( 1 + \frac{δ {σ}_{r}}{{E}_{r}} ) {t}_{f 0} & ( 21 ) \\ h = ( \frac{( {T}_{w} {\vert}_{r = s} + {μ}_{eff 0} ( N / W ) ) / s + {P}_{a}}{\vert {σ}_{r} \vert + {P}_{a}} ) {h}_{0} & ( 22 )\end{matrix}$$

The radial Young's modulus of the nonaqueous electrolyte secondary battery separator is obtained using Equation (23) below, where C₀ and C₁ can be calculated from values actually observed during testing.

[Math.16]

Eᵣ=C₀{1−exp(−|σᵣ|/C₁)} (23)

Winding equation (8) is solved as follows. First, the differential equation is discretized, and a relational expression is derived for three stress increments δσᵣ(i+1), δσᵣ(i), and δσᵣ(i−1). The respective coefficients of each stress increment are represented as Ai, Bi, and Ci, and a constant term quantitatively including the winding tension distribution function T_{w}(r) is represented as Di, so as to obtain the following:

Ai×δσᵣ(i+1)+Bi×δσᵣ(i)+Ci×δσᵣ(i−1)=Di[T_{w}(r)] (i=2˜n)

In a case where i=n, it is possible to obtain δσᵣ(n+1) (where i=n+1 is the outermost layer) by using the boundary condition of Equation (15). As such, the above becomes a relational expression for δσᵣ(n) and δσᵣ(n−1). There are an n number of unknowns, from δσᵣ(1) of the first layer to δσᵣ(n) of the n-th layer.

In the above winding equation, there are an (n−1) number of unknowns. As such, another equation is required to solve the above winding equation), but here the boundary condition of Equation (17) is utilized. The stress increment δσᵣ(i) (i=1˜n) is obtained by simultaneously solving these n number of equations. Subsequently, with δσᵣᵢⱼ=δσᵣ(j) (j=i+1˜n+1), it is possible to obtain the radial stress σᵣᵢ from Equation (1).

A more specific example is as follows. In a case where, for example, a number of turns is 1,000, n=2 is used initially, and a simultaneous equation with two unknowns is solved to obtain δσᵣ(1) and δσᵣ(2). Next, the number of turns is increased by one so as to be n=3, and a simultaneous equation with three unknowns is solved. In doing so, coefficient B includes (E_{teq}/E_{req}), obtained from Equations (18) and (19), and becomes a function of radial stress σᵣ. For this reason, coefficient B is called a non-linear differential equation. For this non-linear differential equation, a method of iterative approximation of solutions is employed, where an approximation of coefficient B is obtained by using the calculation results obtained for n=2.

In this manner, each time the number of turns increase, coefficient B is approximated by using the calculation results obtained for the previous number of turns, and a simultaneous equation having a number of unknowns equivalent to the number of turns is solved. Ultimately, the calculations finish upon the solution of a simultaneous equation with 1,000 unknowns.

Note that with regards to a method for solving simultaneous equations, methods such as direct methods and indirect methods are known, but the method to be employed can be chosen in view of precision of calculations and cost of calculations. Used here is Gaussian elimination, which is one type of direct method that has a high cost of calculation but superior precision of calculation.

Finally, the tangential stress σₜ can be obtained via Equation (24) below by using the radial stress σᵣ. Discretization is utilized in this case as well.

$$\begin{matrix}[ Math . 17 ] & \\ {σ}_{t} = r \frac{d {σ}_{r}}{d r} + {σ}_{r} & ( 24 )\end{matrix}$$

Analyzing stress in the separator roll can thus be described as above. From the results of this analysis, the following items in particular are used in calculations when examining optimization as discussed in the following description:
distribution of radial stress
radial stress at a position equivalent to 95% of maximum winding radius (a position equivalent to 95% of a length from the center of the core to the outermost layer of the separator roll)
distribution of tangential stress
minimum value of tangential stress

[Optimization]

The following description will discuss, in detail, a method of optimization. Here, the winding tension distribution function is described, with reference to FIG. 6, by using an example involving division into fifths in the radial direction. Note that although the number of divisions is not limited, an increase in the number of divisions causes an increase in calculation variables and thus an increase in the cost of calculations. It is therefore preferable for the number of divisions to be the required minimum. The number of divisions is, generally, in a range from three to ten.

Here, the index i is used as a number for a division point, where the core surface is i=0, and the outermost layer is i=5. A radial position r at each division point i is represented by rᵢ, and a winding tension at each division point i is represented by a design variable X[i]. Before optimization is carried out, an initial value of X[i] is set to be a temporary value. For example, a conventional fixed tension distribution or a tapered tension distribution can be used as the initial value.

A cubic spline function shown in Equation (25) below is used as the winding tension distribution function. Note that the index i represents integers from 0 through 4 (4 being obtained by subtracting 1 from the number of divisions, i.e., from 5). δr represents a radial division interval. With regards to factors other than winding tension, such as nip load, for which distribution optimization is to be carried out, a cubic spline function similar to that of Equation (25) can be used. Note, however, that an increase in distribution optimization factors will cause an increase in design variables and cost of calculations. As such, it is preferable to select distribution optimization factors in accordance with, for example, the specifications of the winding device and the method of use thereof. The following description will exemplarily discuss the optimization of winding tension distribution.

$$\begin{matrix} [ Math . 18 ] & \\ {T}_{w} ( r ) = ( \frac{{M}_{i}}{6 Δ r} ) {( {r}_{i + 1} - r )}^{3} + ( \frac{{M}_{i + 1}}{6 Δ r} ) {( r - {r}_{i} )}^{3} + ( X [ i ] - \frac{{M}_{i} Δ {r}^{2}}{6} ) \frac{{r}_{i + 1} - r}{Δ r} + ( X [ i + 1 ] - \frac{{M}_{i + 1} Δ {r}^{2}}{6} ) \frac{r - {r}_{i}}{Δ r} & ( 25 )\end{matrix}$$

Here, because first derivatives at each division point i are continuous, the relation expressed by Equation (26) holds true for a shape parameter Mᵢ. Note that the index i takes a value from 0 through 3.

[Math.19]

Mᵢ+4Mᵢ₊₁+Mᵢ₊₂=6(X[i]−2X[i+1]+X[i+2])/Δr²=aᵢ₊₁ (26)

Further, by setting the respective first derivatives at each end as a slope between two points, Equation (27) below holds true.

[Math.20]

2M₀+M₁=0 2M₅+M₄=0 (27)

By using Equations (26) and (27) to solve a simultaneous equation with 6 unknowns with respect to Mᵢ, it ultimately becomes possible to obtain Mᵢ by using Equation (28).

[Math.21]

M₁=(194a₁−52a₂+14a₃−4a₄)/627

M₀=−M₁/2 M₂=a₁−7M₁/2

M₃=a₂−4a₁+13M₁ M₄=2(a₄−M₃)/7 M₅=−M₄/2 (28)

The above makes it possible to calculate, from Equation (25), the tension T_{w}(r) between division points i and i+1, i.e., between radial positions rᵢ and rᵢ₊₁. By starting with index i at a value of 0 and sequentially increasing the value up to 4, it is possible to calculate the tension distribution from the core surface to the outermost layer.

Optimization of the winding tension distribution function T_{w}(r) can be replaced by a mathematical problem of finding a design variable X which minimizes an expanded objective function F(X), the expanded objective function F(X) being the sum of (a) an objective function f(X) and (b) a penalty function P(X) (described later). Sequential quadratic programming is a known method for solving this mathematical problem.

expanded objective function F(X)=objective function f(X)+penalty function P(X) (29)

The method disclosed in Non-Patent Literature 4, however, requires significant calculating time when solving for a penalty coefficient to use in the penalty function. Furthermore, Non-Patent Literature 4 discloses a direct search method as a method for obtaining step size, but no details thereof are disclosed, thus rendering the specific calculation method unclear. The following description will provide a specific method which is improved such that calculating time is shortened.

The design variable X is a column vector and is expressed by Equation (30) below. In a case where the winding tension X[0] at the beginning of winding, i.e., at the core surface, is completely unknown, the winding tension X[0] may be included in the design variable. However, since the winding tension X[0] is often determined empirically, such as by winding at a conventional fixed tension or tapered tension distribution, the following example treats the winding tension X[0] as a fixed value excluded from the design variable. This winding tension X[0] is also used for nondimensionalization of the objective function (later described).

$$\begin{matrix}[ Math . 22 ] & \\ X = ( \begin{matrix}X [ 1 ] \\ X [ 2 ] \\ X [ 3 ] \\ X [ 4 ] \\ X [ 5 ]\end{matrix} ) & ( 30 )\end{matrix}$$

The objective function f(X) is defined by Equation (31) below.

$$\begin{matrix}[ Math . 23 ] & \\ f ( x ) = {\sum }_{i = 1}^{n - 1} ( {{( \frac{{F}_{i}}{{F}_{cr}} - 1 )}^{2}}^{Frictional force} + {{( \frac{{σ}_{t , i}}{{σ}_{t , ref}} )}^{2}}^{Tangential stress} ) & ( 31 )\end{matrix}$$

The objective function is obtained as the summation, for a number of divisions n, of (a) frictional force Fᵢ between nonaqueous electrolyte secondary battery separator layers at each division point i and (b) tangential stress σ_{t,i} at each division point i. The frictional force Fᵢ and the tangential stress σ_{t,i} are obtained by referencing the results of analysis of internal stress in the separator roll as described above. Here, the frictional force Fᵢ can be obtained from Equation (33) below, F_{cr} represents a critical frictional force at which slippage begins, and σ_{t,ref} is a reference value of tangential stress. Since Fᵢ and F_{cr} are of the same dimension, and σ_{t,i} and σ_{t,ref} are also of the same dimension, dividing Fᵢ by F_{cr} and σ_{t,i} by σ_{t,ref} renders the objective function a dimensionless value. Note that the critical frictional force is defined as a value where slippage can occur when the frictional force is less than the critical frictional force.

In the summation, the division point i is in a range from i=1 through n−1. The reason for excluding i=0 is that the tension X[0] at the beginning of winding is set to a fixed value and excluded from the design variable. The reason for excluding the i=n, i.e., the outermost layer, is that frictional force F there will be 0 in all cases.

The reference value σ_{t,ref} is defined by Equation (32) below. Specifically, the reference value σ_{t,ref} is defined as stress (unit: N/m²=Pa) obtained by dividing (a) tension (unit: N/m) at the beginning of winding, which tension is a fixed value, by (b) an initial nonaqueous electrolyte secondary battery separator thickness (unit: m).

[Math.24]

σ_{t,ref}=X[0]/t_{f0} (32)

Frictional force Fᵢ between nonaqueous electrolyte secondary battery separator layers at each division point i is defined by Equation (33). The product of (a) circumferential length (2πrᵢ) and (b) nonaqueous electrolyte secondary battery separator width (W) is the area (S) on which the frictional force acts. The product of (a) the area (S) and (b) the absolute value (|σᵣᵢ|) of radial stress applied normally to this area is normal force. Frictional force is defined as the product of (a) the normal force and (b) the coefficient of friction (μ_{eff})

[Math.25]

Fᵢ=2πrᵢμ_{eff}|σᵣᵢ|W (33)

The separator roll in accordance with an embodiment of the present invention has a coefficient of friction (μ_{eff}) between nonaqueous electrolyte secondary battery separator layers that is defined by Equation (34). This coefficient of friction (μ_{eff}) is not a function of the initial value of the air layer thickness (h₀) at the nipped portion, but rather a function of the air layer thickness (h) of the compressed air layer after winding, as calculated in Equation (22).

$$\begin{matrix}[ Math . 26 ] & \\ {μ}_{eff} = \{ \begin{matrix}{μ}_{ff} & ( h < {σ}_{ff} ) \\ \frac{{μ}_{ff}}{2} ( 3 - \frac{h}{{σ}_{ff}} ) & ( {σ}_{ff} ≦ h ≦ 3 {σ}_{ff} ) \\ 0 & ( h > 3 {σ}_{ff} )\end{matrix} & ( 34 )\end{matrix}$$

The following description will discuss constraint conditions. Equations (35) and (36) define constraint conditions with regards to the design variable X, the minimum value σ_{t,min} of tangential stress, and frictional force F95 between nonaqueous electrolyte secondary battery separator layers. Here, m represents the number of constraint condition functions g. Specifically, from Equation (36), m is 12. In a case where one of the constraint condition functions g does not satisfy Equation (35), a penalty (described later) is imposed, and the expanded objective function F increases in value and deteriorates.

$$\begin{matrix}[ Math . 27 ] & \\ {g}_{i} ( X ) ≦ 0 \\ ( i = 1 \sim m ) & ( 35 ) \\ {g}_{1} ( X ) = \frac{0 - X [ 1 ]}{X [ 0 ]} \\ {g}_{2} ( X ) = \frac{X [ 1 ] - 2 X [ 0 ]}{X [ 0 ]} \\ {g}_{3} ( X ) = \frac{0 - X [ 2 ]}{X [ 0 ]} \\ {g}_{4} ( X ) = \frac{X [ 2 ] - 2 X [ 0 ]}{X [ 0 ]} \\ {g}_{5} ( X ) = \frac{0 - X [ 3 ]}{X [ 0 ]} \\ {g}_{6} ( X ) = \frac{X [ 3 ] - 2 X [ 0 ]}{X [ 0 ]} \\ {g}_{7} ( X ) = \frac{0 - X [ 4 ]}{X [ 0 ]} \\ {g}_{8} ( X ) = \frac{X [ 4 ] - 2 X [ 0 ]}{X [ 0 ]} \\ {g}_{9} ( X ) = \frac{0 - X [ 5 ]}{X [ 0 ]} \\ {g}_{10} ( X ) = \frac{X [ 5 ] - 2 X [ 0 ]}{X [ 0 ]} \\ {g}_{11} ( X ) = \frac{- {σ}_{t , m i n}}{{σ}_{t , ref}} \\ {g}_{12} ( X ) = \frac{Fcr - F 95}{Fcr} & ( 36 )\end{matrix}$$

Here, the constraint condition functions are nondimensionalized in the same manner as the objective function. Constraint condition functions g₁ through g₁₀ are defined from a range of values which the value of the design variable X[i] (i=1˜5) can take. The range of values is not particularly limited, and can be determined from the tension range specified for the winding device. Here, the constraint condition functions g₁, g₃, g₅, g₇ and g₉ are defined by using a minimum value of 0. In a case where the design variable X has become a negative value, the constraint condition functions g become positive. In such a case, since the constraint conditions (35) are not satisfied, the penalty is imposed. The constraint condition functions g₂, g₄, g₆, g₈, and g₁₀, on the other hand, are defined by using an example where the maximum value is a value that is twice the tension X[0] at the beginning of winding. In a case where the design variable X exceeds 2X[0], the constraint condition functions g become positive. In such a case, since the constraint conditions (35) are not satisfied, the penalty is imposed.

Note that σ_{t,min} of constraint condition function g₁₁ is a minimum value of tangential stress distribution. In a case where this minimum value has become a negative value, the external defect known as wrinkling is likely to occur. In such a case, the constraint condition function g₁₁ takes on a positive value, the constraint conditions (35) are not satisfied, and the penalty is imposed.

Furthermore, in a case where the frictional force F95 is less than the critical frictional force F_{cr}, the external defect known as slippage is likely to occur. In such a case, the constraint condition function g₁₂ takes on a positive value, the constraint conditions (35) are not satisfied, and the penalty is imposed.

Discussed next is the penalty function P(X). With regards to a method for imposing a penalty in nonlinear programming, typically known methods include, for example, exterior point methods and interior point methods. Here, an exterior point method is used exemplarily. In an exterior point method, the penalty is imposed in a case where the design variable X does not satisfy the constraint conditions.

Specifically, the penalty function P(X) is defined by Equation (37), and the expression max{0,gᵢ(X)} therein is defined by Equation (38). In other words, max{0,gᵢ(X)} is defined as taking on whichever value is greater, 0 or gᵢ(X). In a case where the constraint conditions are satisfied, 0 is returned, and the penalty function P(X) does not increase. In a case where the constraint conditions are not satisfied, a positive value of g is returned, and the penalty function P(X) increases.

Note that p in Equation (37) is a penalty coefficient and is a positive constant. The penalty coefficient p is preferably increased with each recursion step (k) (described later). In terms of reducing the cost of calculations, it is preferable to use the Sequential Unconstrained Minimization Technique (SUMT), which aims to sequentially arrive at an optimal solution as an expanded objective function F(X) with a small penalty transitions to an expanded objective function with a large penalty. A specific method of increase is provided in Equation (39), where p is multiplied by c with each recursion step. A possible example is p(1)=1000, c=2.

$$\begin{matrix}[ Math . 28 ] & \\ P ( X ) = p \times {\sum }_{i = 1}^{i = m} {\vert max \{ 0 , {g}_{i} ( X ) \} \vert}^{2} & ( 37 ) \\ max \{ 0 , {g}_{i} ( X ) \} = \{ \begin{matrix}0 & ( {g}_{i} ( X ) ≦ 0 ) \\ {g}_{i} ( X ) & ( {g}_{i} ( X ) > 0 )\end{matrix} & ( 38 ) \\ p ( k + 1 ) = p ( k ) \times c & ( 39 )\end{matrix}$$

The objective function f(X) and the penalty function P(X) are described as above, and a summation of these provides the expanded objective function F(X). Optimization of the winding tension distribution function T_{w}(r) can be replaced by Equation (40), as the mathematical problem to find a design variable X to minimize the expanded objective function F(X) (Find X to minimize . . . subject to . . . ). This mathematical problem is solved by using nonlinear programming described later.

[Math.29]

Find X to minimize F(X)=f(X)+P(X)subject to gᵢ(X)≦0 (i=1˜m) (40)

The following description will discuss a flow of calculations in the nonlinear programming. Calculations proceed as in Steps 1 through 8. A description of each step is as follows.

Step 1: Set various parameters such as an initial value of the design variable X(k), an initial value of the penalty coefficient p(k), and physical property values. k: number of recursion steps=1

Step 2: Find a search vector d(k) to minimize the expanded objective function F.

d(k)=−B(k)⁻¹·∇F(X(k))

B: Hessian matrix, ∇F: gradient vector

Step 3: If d(k)=0, it is deemed that convergence has occurred, and the calculations end. Otherwise, proceed to Step 4, and repeat Steps 2 through 8 until d(k)=0.

Step 4: Use the Armijo rule to obtain a step size Step(k).

Step 5: Update the design variable.

X(k+1)=X(k)+Step(k)×d(k)

Step 6: Update the penalty coefficient.

p(k+1)=p(k)×C

Step 7: Use a quasi-Newton method, BFGS formula to obtain a Hessian matrix B(k+1).

Step 8: Set k=k+1 and return to Step 2.

<Step 1>

In Step 1, various parameters necessary for solving the winding equation are set. Examples include (a) physical property values of the nonaqueous electrolyte secondary battery separator, (b) property values of the core and the nip roller, and (c) winding conditions. An initial value of the design variable X(k), an initial value of the penalty coefficient p(k), and the like are set as parameters of nonlinear programming. The number of recursion steps k is set to 1.

<Step 2>

In Step 2, the search vector d(k) which minimizes the expanded objective function F(X) is found. The search vector is defined in Equation (41). The gradient vector ∇F and the Hessian matrix B are defined in Equations (42) and (43), respectively. Note that B⁻¹ is an inverse matrix of B, and X₁ through X₅ of Equations (42) and (43) represent the design variable X[i] (i=1˜5). As can be seen from Equations (42) and (43), because the expanded objective function F is differentiated with respect to the design variable X, it is possible to find which direction of movement of the design variable X will enable minimization of the expanded objective function F.

$$\begin{matrix}[ Math . 30 ] & \\ d ( k ) = - {B}^{- 1} \cdot ∇ F & ( 41 ) \\ ∇ F ( X ( f ) ) = ( \begin{matrix}\partial F / δ {X}_{1} \\ \partial F / \partial {X}_{2} \\ \partial F / \partial {X}_{3} \\ \partial F / \partial {X}_{4} \\ \partial F / \partial {X}_{5}\end{matrix} ) & ( 42 ) \\ B = ( \begin{matrix}\frac{{\partial }^{2} F}{\partial {X}_{1} \partial {X}_{1}} & \frac{{\partial }^{2} F}{\partial {X}_{1} \partial {X}_{2}} & \frac{{\partial }^{2} F}{\partial {X}_{1} \partial {X}_{3}} & \frac{{\partial }^{2} F}{\partial {X}_{1} \partial {X}_{4}} & \frac{{\partial }^{2} F}{\partial {X}_{1} \partial {X}_{5}} \\ \frac{{\partial }^{2} F}{\partial {X}_{2} \partial {X}_{1}} & \frac{{\partial }^{2} F}{\partial {X}_{2} \partial {X}_{2}} & \frac{{\partial }^{2} F}{\partial {X}_{2} \partial {X}_{3}} & \frac{{\partial }^{2} F}{\partial {X}_{2} \partial {X}_{4}} & \frac{{\partial }^{2} F}{\partial {X}_{2} \partial {X}_{5}} \\ \frac{{\partial }^{2} F}{\partial {X}_{3} \partial {X}_{1}} & \frac{{\partial }^{2} F}{\partial {X}_{3} \partial {X}_{2}} & \frac{{\partial }^{2} F}{\partial {X}_{3} \partial {X}_{3}} & \frac{{\partial }^{2} F}{\partial {X}_{3} \partial {X}_{4}} & \frac{{\partial }^{2} F}{\partial {X}_{3} \partial {X}_{5}} \\ \frac{{\partial }^{2} F}{\partial {X}_{4} \partial {X}_{1}} & \frac{{\partial }^{2} F}{\partial {X}_{4} \partial {X}_{2}} & \frac{{\partial }^{2} F}{\partial {X}_{4} \partial {X}_{3}} & \frac{{\partial }^{2} F}{\partial {X}_{4} \partial {X}_{4}} & \frac{{\partial }^{2} F}{\partial {X}_{4} \partial {X}_{5}} \\ \frac{{\partial }^{2} F}{\partial {X}_{5} \partial {X}_{1}} & \frac{{\partial }^{2} F}{\partial {X}_{5} \partial {X}_{2}} & \frac{{\partial }^{2} F}{\partial {X}_{5} \partial {X}_{3}} & \frac{{\partial }^{2} F}{\partial {X}_{5} \partial {X}_{4}} & \frac{{\partial }^{2} F}{\partial {X}_{5} \partial {X}_{5}}\end{matrix} ) & ( 43 )\end{matrix}$$

In describing the differentiation of the expanded objective function F with respect to design variable X, it is possible to use Equation (44) to exemplarily illustrate a gradient vector.

$$\begin{matrix}[ Math . 31 ] & \\ ∇ F ( X ) = ( \begin{matrix}\frac{\partial F}{\partial {X}_{1}} \\ \frac{\partial F}{\partial {X}_{2}} \\ \frac{\partial F}{\partial {X}_{3}} \\ \frac{\partial F}{\partial {X}_{4}} \\ \frac{\partial F}{\partial {X}_{5}}\end{matrix} ) = ( \begin{matrix}\frac{F ( {X}_{1} + x ) - F ( X )}{ x} \\ \frac{F ( {X}_{2} + x ) - F ( X )}{ x} \\ \frac{F ( {X}_{3} + x ) - F ( X )}{ x} \\ \frac{F ( {X}_{4} + x ) - F ( X )}{ x} \\ \frac{F ( {X}_{5} + x ) - F ( X )}{ x}\end{matrix} ) & ( 44 )\end{matrix}$$

As described above, with the expanded objective function F, it is necessary to solve the winding equation in accordance with the temporarily set design variable and the like. The objective function f(X) and the penalty function P(X) are obtained from the result of solving the winding equation, and the two are totaled to obtain the expanded objective function F.

As such, since the expanded objective function F is not a function in which the design variable X is explicitly expressed as a mathematical expression, it is necessary to employ numerical differentiation instead of differentiation of the expanded objective function F. The method of numerical differentiation is not particularly limited, but, for example, a high-order differential equation having first-order accuracy or second-order accuracy, in accordance with accuracy requirements, can be used. Equation (44) is an example using a differential equation which has first-order accuracy.

It is necessary to obtain (a) the derivative of the expanded objective function F(X) with respect to the design variable X, and (b) the derivative of the expanded objective function F(X+δX) with respect to a design variable (X+δX), where a small increment δX has been added to X. As such, in a case where there are five design variables, in order to obtain the gradient vector it is necessary to solve the winding equation a total of six times. In this way, an increase in design variables increases the cost of calculations. A high-order accuracy of differentiation will similarly increase the cost of calculations, and as such the order is preferably first- or second-order.

<Step 3>

In Step 3, it is determined whether or not convergence of calculations has occurred. In a case where the search vector d(k) can be considered to be substantially 0, it is deemed that convergence has occurred, and the calculations end. Otherwise, calculations proceed to Step 4, and Steps 2 through 8 are repeated until d(k)=0.

<Step 4>

When the recursion step is repeated from k to k+1, the design variable is updated from X(k) to X(k+1) in the direction of the search vector d(k). In Step 4, the size by which the search vector d(k) is multiplied is determined. This size is defined as step size Step(k) and can be obtained by using the Armijo rule as shown in Equations (45) and (46).

[Math.32]

F{X[k]+β^{lar}d(k)}−F(X[k])≦α·β^{lar}∇F(X[k])^{T}·d(k) (45)

Step(k)=β^{lar} (46)

Here, α and β are constants from 0 to 1. The smallest non-negative integer lar which satisfies Equation (45) is found, and then the step size Step(k) is obtained from Equation (46).

The right side of Equation (45) includes a gradient vector, where the index T represents a transposed matrix. That is, since the gradient vector is a column vector, the transposed matrix is a row vector. Since the search vector d(k) is a column vector, the right side of Equation (45) is the product of a row vector and a column vector, i.e., a scalar value. The left side of Equation (45) is the difference between expanded objective functions and is a scalar value.

The Armijo rule starts with integer lar at 0, successively increasing to 1 and 2 thereafter, and the first integer to satisfy Equation (45) is found. Note that a smaller value of a corresponds to an increase in speed with which integer lar can be found. As such, α=0.0001 is used here as a non-limiting example. β can be exemplified as 0.5.

<Step 5>

In Step 5, the search vector d(k) obtained in Step 2 and the step size Step(k) obtained in Step 4 are used in Equation (47) to update the design variable from X(k) to X(k+1).

X(k+1)=X(k)+Step(k)×d(k) (47)

<Step 6>

In Step 6, Equation (39) is used to update the penalty coefficient from p(k) to p(k+1).

[Math.33]

p(k+1)=p(k)×c (39)

<Step 7>

In Step 7, the Hessian matrix is updated from B(k) to B(k+1). As shown in Equation (43), the Hessian matrix B is obtained by second-order differentiation of the expanded objective function F using the design variable. Using a Newton method to obtain the Hessian matrix B is impractical, as it would cause a great increase in the cost of calculations.

To address this issue, the quasi-Newton method as shown in Equation (48) is typically used to render calculations more feasible. The search vector d(k) obtained in Equation (41) uses an inverse matrix H(k) of the Hessian matrix B(k), and thus a BFGS (Broyden-Fletcher-Goldfarb-Shanno) formula is shown for the updating of H(k).

$$\begin{matrix} [ Math . 34 ] & \\ H ( k + 1 ) = H ( k ) - \frac{H ( k ) Y ( k ) {( s ( k ) )}^{T} + s ( k ) {( H ( k ) Y ( k ) )}^{T}}{{( s ( k ) )}^{T} Y ( k )} + ( 1 + \frac{{( Y ( k ) )}^{T} H ( k ) Y ( k )}{{( s ( k ) )}^{T} Y ( k )} ) \frac{s ( k ) {( s ( k ) )}^{T}}{{( s ( k ) )}^{T} Y ( k )} & ( 48 )\end{matrix}$$

Here, s(k) is a column vector of the difference between design variables X as shown in Equation (49), and Y(k) is a column vector of the difference between gradient vectors ∇F, as shown in Equation (50).

[Math.35]

s(k)=X(k+1)−X(k) (49)

Y(k)=∇F(X(k+i))−∇F(k) (50)

A unit matrix is used as H(1), a unit matrix being a matrix whose diagonal component is all ones.

<Step 8>

In Step 8, the recursion step k is set to k+1, and calculations return to Step 2.

Convergence is approached by repeating the series of calculations of Steps 1 through 8. The number of recursion steps required for convergence differs depending on, for example, the initial value of the design variable, but will typically be in an approximate range from several times to ten times. Note that in order to avoid a local optimal solution and find a global optimal solution, the initial value can be altered a number of times to confirm that the same solution is obtained.

### EXAMPLES

The following methods were used to measure physical property values of (a) the respective separator rolls produced in the following Examples and Comparative Examples, and (b) the respective cores and nonaqueous electrolyte secondary battery separators constituting the separator rolls.

[Size of Core and Nonaqueous Electrolyte Secondary Battery Separator]

Thickness of the nonaqueous electrolyte secondary battery separator was measured in conformance with JISK7130 (Plastics—Film and sheeting—Determination of thickness). A high-accuracy digital length measuring machine manufactured by Mitutoyo Corporation was used. Length of the separator was measured using an encoder length measuring apparatus. All other dimensions were measured using a slide caliper.

[Critical Stress of Core]

In a simulation using elastic theory and finite element analysis, external pressure was applied to a core, prior to winding of the nonaqueous electrolyte secondary battery separator, to calculate an amount of stress which would cause the core to yield. As a result, it was found that in a case where a stress of 2.0 MPa is applied, a maximum value of Von Mises stress in the core was 40 MPa, which is the yield stress of the ABS resin used as the material of the core. The value of applied external force was multiplied by a safety factor of 0.5, and the critical stress σ_{cr} of the core was calculated to be 1.0 MPa.

[Radial Young's Modulus of Core]

The radial Young's modulus of the core was calculated via a simulation using elastic theory and finite element analysis. The conditions of the simulation are as follows.
Core material: ABS resin (tensile Young's modulus: 2 GPa; Poisson's ratio: 0.36)
Core form: innermost diameter: 75 mm; inner circumferential part thickness: 5.4 mm
   Outermost diameter: 152 mm; outer circumferential part thickness: 5.9 mm
   Ribs: total of eight, provided at intervals of 45°; thickness: 5.4 mm; width: 65 mm

[Young's Modulus of Nonaqueous Electrolyte Secondary Battery Separator]

A TANGENTIAL Young's modulus Eₜ and a radial Young's modulus Eᵣ of the nonaqueous electrolyte secondary battery separator was measured via a tension test and a compression test as shown in FIG. 3 and FIG. 4, respectively. Measurement apparatuses and measurement conditions used in the tests are as follows.

Tension Test:
Measurement apparatus: Manufactured by INSTRON, model no. 5982
Measurement conditions: In conformance with JIS K 7127 (Plastics—Determination of Tensile Properties—Part 3: Test Conditions for Films and Sheets) and JIS K 7161 (Plastics—Determination Of Tensile Properties—Part 1: General Principles). Pulling speed: 10 mm/min.
Test specimen: JIS K 7127 Type 1B.

Compression Test:
Measurement apparatus: Manufactured by INSTRON, model no. 5982
Measurement conditions: In conformance with JIS K 7181 (Plastics—Determination of Compressive Properties). Compression speed: 1.2 mm/min.
Test specimen: 150 mm (length)×60.9 mm (width)×20 mm (thickness) (approx. 1,200 separator layers).

[Strain of Core]

For the separator roll obtained in Example 1, strain of the core thereof was measured as follows. First, the radius (R₀) of the core prior to winding was measured with a slide caliper and was found to be 76.0 mm. This figure is an average of eight measurements performed, specifically four measurements at a midpoint between each of the eight ribs, and four measurements at rib heads. Once the separator roll was obtained, similar measurements were performed to find the radius (R₁) of the core, and strain of the core was obtained as (R₀−R₁)/R₀.

[Analysis Method]

The analysis method described in Embodiment 2 above was used to analyze (a) radial stress σᵣ, (b) tangential stress σₜ, and (c) frictional force F between layers of the nonaqueous electrolyte secondary battery separator, with respect to the distribution of the winding tension T_{w} at a radial position (R/R_{c}).

### Examples 1 Through 3 and Comparative Examples 1 Through 4

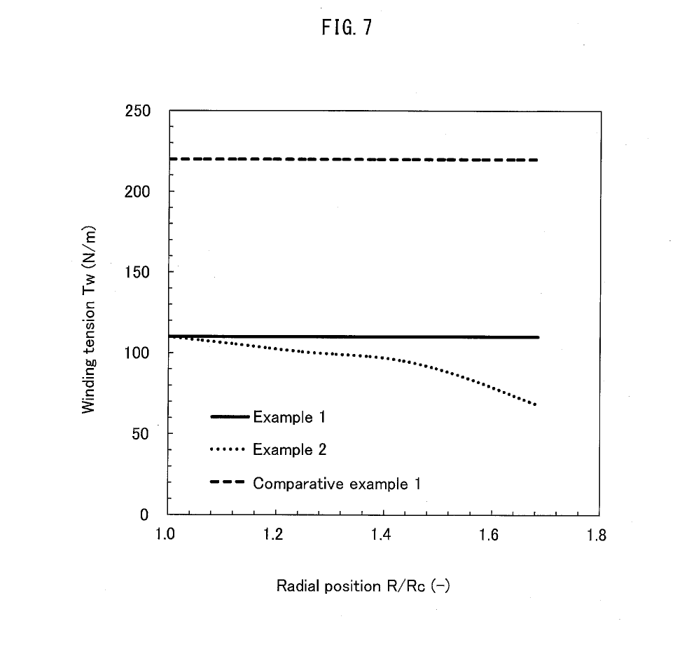

A separator roll was produced in each of the Examples and Comparative Examples as follows. A core made from ABS resin was fixed to a winding spindle of a winding machine, the winding machine being a centrally-driven winding system having a nip roller. The core was then made to rotate such that a nonaqueous electrolyte secondary battery separator was wound therearound. During the winding, the winding tension applied to the respective nonaqueous electrolyte secondary battery separators of the Examples and the Comparative Examples was adjusted, as shown in FIG. 7, by controlling the rotation speed of a motor driving the winding spindle.

In the Examples and the Comparative Examples, various parameters, including (a) the physical properties of the core, (b) the physical property values of the nip roller of the winding machine and (c) the physical properties of the nonaqueous electrolyte secondary battery separator were as shown in Tables 3 and 4 below.

Note that the physical property values of the separators of Comparative Examples 2 and 3 are calculated examples which were set with reference to Patent Literature 1, 2, 3, 5 and 6, which disclose a ratio (Eₜ/Eᵣ) of Young's moduli being in an approximate range from 1,000 to 3,000.

TABLE 3

| | | Ex. 1 | | |
|---|---|---|---|---|
| | | through 3 | | |
| | | and Comp. | Comp. | Comp. |
| | | Ex. 1 and 4 | Ex. 2 | Ex. 3 |
| Core | Young's modulus (Pa) | −2.56E+08 | | |
| | Radius (m) | 0.076 | | |
| Nip roller | Poisson's ratio (—) | 0.3 | | |
| | Young's modulus (Pa) | 2.06E+11 | | |
| | Radius (m) | 0.03 | | |
| Non- | Composite root square | 0.36 | | |
| aqueous | roughness (μm) | | | |
| electrolyte | Coefficient of static | 0.3 | | |
| secondary | friction (—) | | | |
| battery | Thickness (μm) | 16.5 | | |
| separator | Width (m) | 0.0609 | | |
| | Poisson's ratio (—) | 0 | | |
| | Tangential Young's | 1.35E+10 | 7.00E+08 | 1.35E+10 |
| | modulus (Pa) | | | |
| | Radial Young's | 4.42E+07 | 4.42E+07 | 8.00E+08 |
| | modulus | | | |
| | parameter C0 (Pa) | | | |
| | Radial Young's | 1.45E+05 | 1.45E+05 | 1.45E+05 |
| | modulus | | | |
| | parameter C1 (Pa) | | | |

Note:
In Table 3, “Ex.” Stands for Example, and “Comp. Ex.” stands for “Comparative Example.”

TABLE 4

| Parameter | Unit | Value |
|---|---|---|
| Air viscosity | Pa · s | 1.82200E−05 |
| Atmospheric pressure | Pa | 1.01325E+05 |
| Critical frictional force | N | 140 |
| (Example 2 only) | | |
| Nip load | N | 15 |
| Winding speed | m/s | 1.67 |

Table 5 below shows (a) the properties of the nonaqueous electrolyte secondary battery separator used, (b) the critical stress of the core, (c) an overview of winding conditions, (d) strain of the core of the obtained separator roll, and (e) an absolute value of radial stress applied to the core. With regards to the strain of the core, since the actual measured value and the calculated value of Example 1 were quantitatively matched, only the calculated value of the strain of the core is shown for the other Examples and Comparative Examples.

TABLE 5

| | | | | | | | | | Winding results | | |
|---|---|---|---|---|---|---|---|---|---|---|---|
| | Separator properties | | | Winding conditions | | | | | Absolute value | Core strain | |
| | | Er | | Initial | | | Max. | Core | of radial stress | Actual | Calcu- |
| | | (\|σᵣ\| = | | winding | | Winding | winding | Critical | \|σᵣ\| applied to | measured | lated |
| | Et | 1000 Pa) | Et/Er | tension | Tension | length | radius | stress σ_{cr} | core | value | value |
| | Pa | | — | N/m | distribution | m | m | Mpa | Mpa | — | |
| Ex. 1 | 1.35E+10 | 3.04E+05 | 4.44E+04 | 110 | Fixed tension | 2000 | 0.128 | 1.0 | 0.46 | 1.9E−03 | 1.8E−03 |
| Ex. 2 | | | | 110 | Optimized | | | | 0.20 | — | 7.8E−04 |
| Comp. | | | | 220 | Fixed tension | | | | 1.46 | — | 5.7E−03 |
| Ex. 1 | | | | | | | | | | | |
| Ex. 3 | | | | 110 | Fixed tension | 1000 | 0.105 | | 0.51 | — | 2.0E−03 |
| Comp. | 7.00E+08 | 3.04E+05 | 2.30E+03 | | | | | | 9.23 | — | 3.6E−02 |
| Ex. 2 | | | | | | | | | | | |
| Comp. | 1.35E+10 | 5.50E+06 | 2.46E+03 | | | | | | 1.68 | — | 6.6E−03 |
| Ex. 3 | | | | | | | | | | | |
| Comp. | 1.35E+10 | 3.04E+05 | 4.44E+04 | 300 | | | | | 1.99 | — | 7.8E−03 |
| Ex. 4 | | | | | | | | | | | |

Note:
In Table 5, “Ex.” Stands for Example, and “Comp. Ex.” stands for “Comparative Example.”

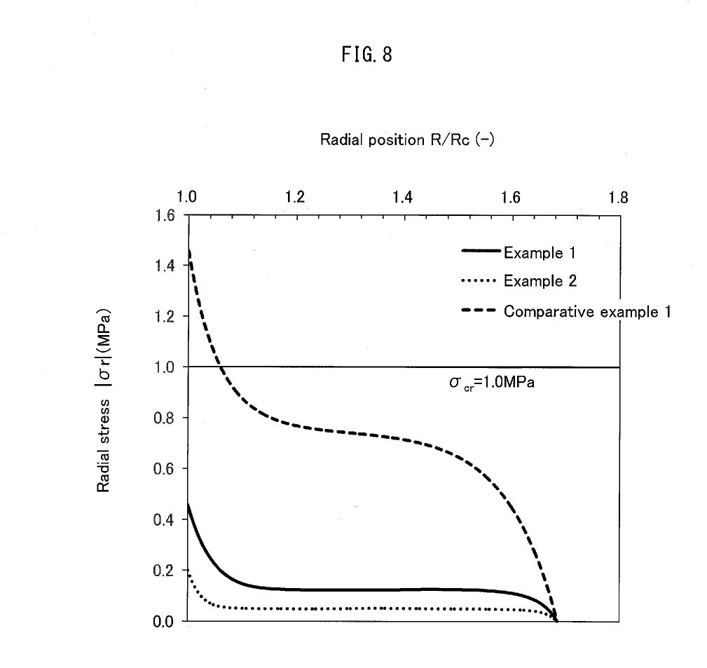

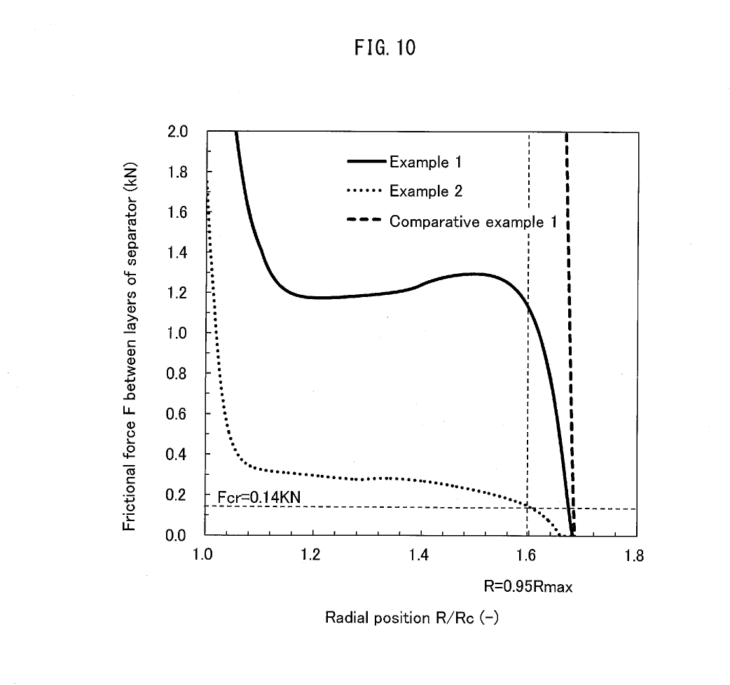

Furthermore, analysis was performed to determine relations, at a given distance R from the center of the core of the separator rolls obtained, between (a) a radial position (R/R_{c}) with respect to the radius R_{c} of core and each of (b) winding tension T_{w}, (c) absolute value of radial stress σᵣ, (d) tangential stress σₜ, and (e) frictional force F between layers of the nonaqueous electrolyte secondary battery separator. The results of this analysis are shown in FIGS. 7 through 10.

[Conclusion]

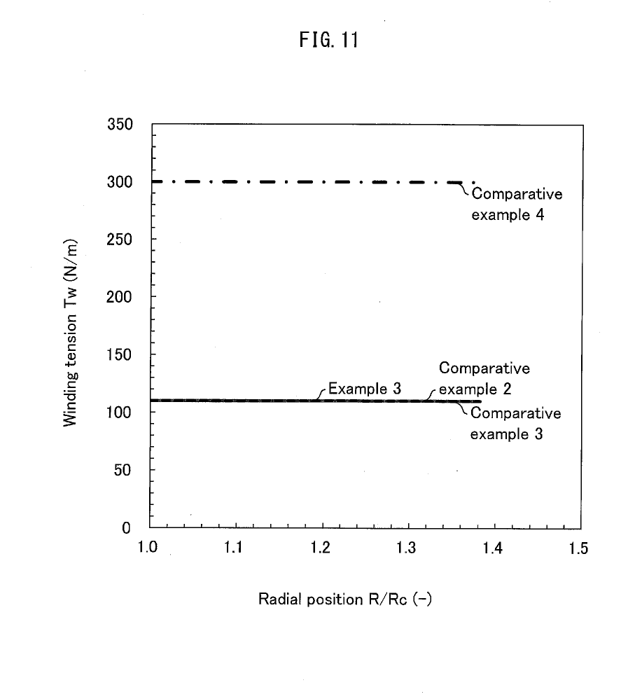

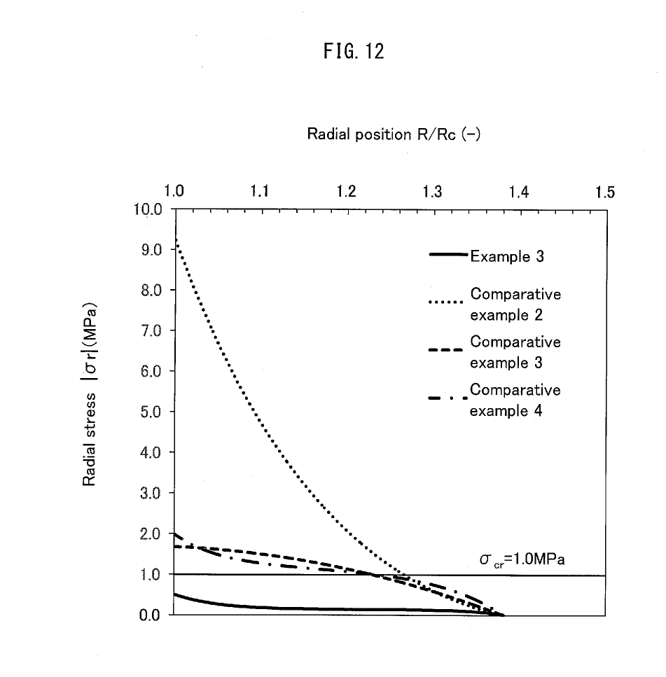

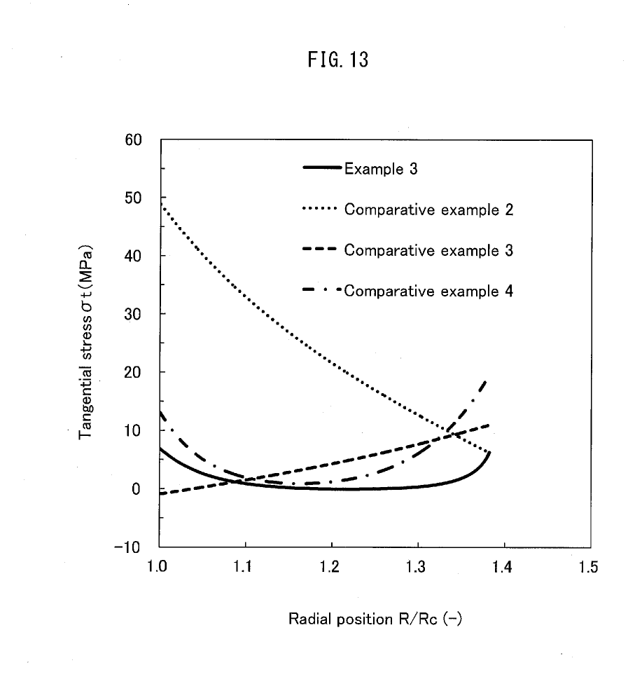

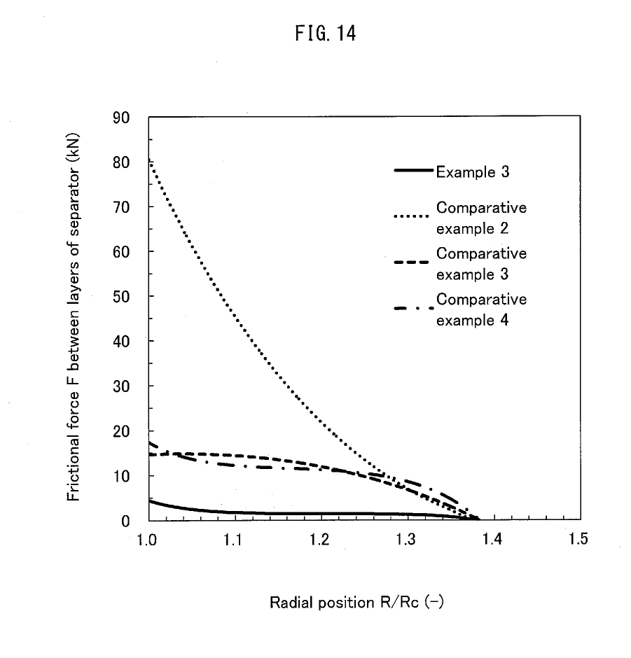

From Table 5 and FIGS. 7 through 14, it is shown that radial stress applied to each of the cores of the respective separator rolls obtained in Examples 1, 2, and 3 was equal to or less than the critical stress of the core.

From FIGS. 7, 8, 11, and 12, it was found that in Examples 1 and 3 and Comparative Examples 1 and 4, the absolute value of radial stress decreased as winding tension decreased. This indicates that appropriately adjusting the winding tension makes it possible to reduce the absolute value of radial stress applied to the core and thus ensure that the radial stress applied to the core in the separator roll is less than the critical stress of the core.

In Comparative Examples 2 and 3, although winding tension and wound length were identical to that of Example 3, the absolute value of radial stress applied to the core of each of the obtained separator rolls was comparatively greater. This is presumed to be due to the difference in the ratios of Young's moduli of the respective nonaqueous electrolyte secondary battery separators. This indicates that it is important to appropriately adjust winding tension in accordance with the type of nonaqueous electrolyte secondary battery separator.

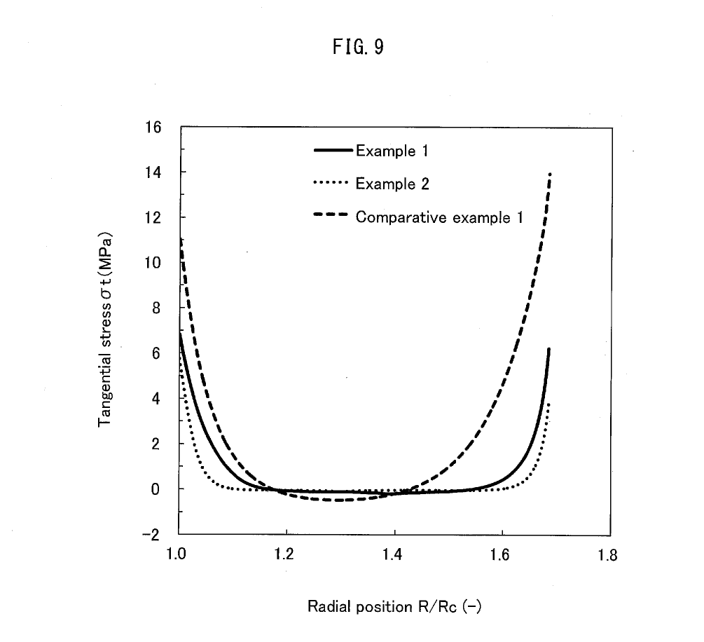

From FIGS. 7 and 9, it was found that in the respective separator rolls of Examples 1 and 2, tangential stress was 0 or a positive value. It was also found that, with the exception of the vicinities of the core and of the outermost layer, tangential stress near a middle of the separator rolls was nearly zero, and the occurrence of creep was therefore inhibited.

In Comparative Example 1, on the other hand, it was found that near a middle of the roll, in a vicinity where R/R_{c} was from 1.2 to 1.4, tangential stress had a negative value. From this, it was found that in the separator rolls of the Examples, in which winding tension was adjusted to be lower than that of Comparative Examples 1 and 4 such that the absolute value of radial stress applied to the core was not greater than the critical stress of the core, tangential stress had a non-negative value and thus the external defect known as wrinkling was prevented.

With regards to Comparative Example 2, it was found that tangential stress thereof, as observed throughout the roll from the core to the outermost layer, took on a high value despite a low winding tension being used. This, too, is presumed to be due to the difference in the ratios of Young's moduli of the respective nonaqueous electrolyte secondary battery separators.

From FIGS. 7, 10, 11, and 14, it was further found that with the exception of Example 2, where the winding tension was optimized through nonlinear programming, all other Examples and Comparative Examples exhibited excessive frictional force between the layers of their respective nonaqueous electrolyte secondary battery separator. With regard to Example 2, on the other hand, it was found that, since an optimized tension distribution was used, the constraint conditions of the nonlinear programming were followed, and thus critical frictional force F_{cr} (0.14 kN) was maintained at a position equivalent to 95% of the maximum winding radius (0.95 Rmax).

The above matters indicate that, by winding a nonaqueous electrolyte secondary battery separator around a core at a suitably adjusted winding tension, it is possible to produce a separator roll in which an absolute value of radial stress applied to the core is equal to or less than the critical stress of the core.

The above matters also indicate that, in a separator roll in which the absolute value of the radial stress applied to the core is equal to or less than the critical stress of the core, tangential stress is also adjusted to a suitable range, and of the exterior of the separator roll is therefore has superior quality.

Furthermore, the above matters indicate that by optimizing winding tension by use of nonlinear programming, it is possible to suitably adjust frictional force. That is, by optimizing winding tension by use of nonlinear programming, it is possible to further improve the quality of the exterior of a separator roll.

As such, it was found that it is possible to prevent deformation of the core and produce a separator roll whose exterior is superior in quality by (a) adjusting winding tension, in accordance with the Young's modulus of the nonaqueous electrolyte secondary battery separator, such that the absolute value of radial stress applied to the core is equal to or less than the critical stress of the core, and (b) winding the nonaqueous electrolyte secondary battery separator around the core at the winding tension adjusted thusly.

### INDUSTRIAL APPLICABILITY

A method, for producing a separator roll, in accordance with an embodiment of the present invention can be used in producing a separator roll having a superior external quality. A separator roll in accordance with an embodiment of the present invention has a superior external quality and is suitable for transportation, storage, and the like. The separator roll can therefore be applied in more efficient production of a nonaqueous electrolyte secondary battery.

1. A separator roll comprising a core and a nonaqueous electrolyte secondary battery separator wound around the core, wherein:
the nonaqueous electrolyte secondary battery separator has a wound length of not less than 1,000 m; and
an absolute value of radial stress σᵣ applied to the core is not more than a critical stress σ_{cr},
the critical stress σ_{cr} being a value obtained by multiplying A by B, where:
A is an absolute value, of radial stress σᵣ applied to the core, as observed in a case where a maximum value of Von Mises stress σₘ in the core is equal to a yield stress σ_{y} of a material of the core; and
B is a safety factor of 0.5.

2. The separator roll as set forth in claim 1, wherein the critical stress σ_{cr} is in a range from 0.2 MPa to 2.0 MPa.

3. The separator roll as set forth in claim 1, wherein a frictional force between layers of the nonaqueous electrolyte secondary battery separator at a position equivalent to 95% of a maximum winding radius is not less than a value obtained by multiplying (a) a mass of the separator roll by (b) an acceleration equal to 10 times gravity.

4. The separator roll as set forth in claim 1, wherein a frictional force between layers of the nonaqueous electrolyte secondary battery separator at a position equivalent to 95% of a maximum winding radius is not less than a value obtained by multiplying (a) a mass of the separator roll by (b) an acceleration equal to 50 times gravity.

5. The separator roll as set forth in claim 1, wherein a tangential stress σₜ is a non-negative value.

6. The separator roll as set forth in claim 1, wherein a ratio (Eₜ/Eᵣ) is in a range from 5×10³ to 5×10⁵, the ratio (Eₜ/Eᵣ) being a ratio of (a) a tangential Young's modulus Eₜ of the nonaqueous electrolyte secondary battery separator to (b) a radial Young's modulus Eᵣ of the nonaqueous electrolyte secondary battery separator, which radial Young's modulus Eᵣ is observed in a case where an absolute value of radial stress applied to the nonaqueous electrolyte secondary battery separator is 1,000 Pa.

7. A method for producing the separator roll as set forth in claim 1, the method comprising a winding step of winding the nonaqueous electrolyte secondary battery separator around the core, wherein:
out of winding conditions of the winding step, at least a winding tension distribution is optimized in accordance with nonlinear programming.
